(19) United States
(12) Patent Application Publication
(10) Pub. No.: US 2013/0230770 A1
(43) Pub. Date: Sep. 5, 2013

(54) NON-AQUEOUS SECONDARY BATTERY

(71) Applicants: Masayuki Oya, Ibaraki-shi (JP); Mitsuhiro Kishimi, Ibaraki-shi (JP); Fusaji Kita, Ibaraki-shi (JP)

(72) Inventors: Masayuki Oya, Ibaraki-shi (JP); Mitsuhiro Kishimi, Ibaraki-shi (JP); Fusaji Kita, Ibaraki-shi (JP)

(73) Assignee: HITACHI MAXELL, LTD., Ibaraki-shi, Osaka (JP)

(21) Appl. No.: 13/885,577

(22) PCT Filed: Nov. 15, 2011
(86) PCT No.: PCT/JP2011/076273

§ 371 Date: May 15, 2013

(30) Foreign Application Priority Data
Nov. 16, 2010 (JP) 2010-255537
Feb. 21, 2011 (JP) 2011-034078

(51) Int. Cl. H01M 4/131; H01M 10/0525; H01M 10/0564

(52) U.S. Cl. CPC H01M 4/131; H01M 10/0564; H01M 10/0525
USPC 429/199; 429/188

(57) ABSTRACT

A non-aqueous secondary battery of the present invention includes a positive electrode, a negative electrode, a separator and a non-aqueous electrolyte. The positive electrode includes a lithium-containing composite oxide as a positive electrode active material, expressed by a general compositional formula (1): Li_{1+y}MO₂ where −0.5≦y≦0.5. M denotes an element group including Ni and at least one element selected from the group consisting of Co, Mn, Fe and Ti. And the non-aqueous electrolyte includes a cycloalkane derivative A having at least one alkyl ether group containing an unsaturated bond, and at least one compound selected from the group consisting of an azacrown ether compound B having a functional group where at least one of nitrogen atoms contains an unsaturated bond and a nitrogen-containing heterocyclic compound C.

### TECHNICAL FIELD

The present invention relates to a non-aqueous secondary battery exhibiting excellent charge/discharge cycle characteristics and excellent storage characteristics.

### BACKGROUND ART

Non-aqueous secondary batteries such as lithium ion secondary batteries are used as power sources for electronic devices such as mobile phones and notebook computers because of the high voltage and high capacity, and their application has been expanded to electric vehicles and so forth. And as devices to which non-aqueous secondary batteries are applied are making further advancement, improvement in various characteristics such as capacity of non-aqueous secondary batteries is required for example.

As one of the techniques for improving such non-aqueous secondary batteries, application of additives to the non-aqueous electrolyte have been known (see Patent documents 1-3 for example).

### PRIOR ART DOCUMENTS

### Patent Documents

Patent document 1: JP 2010-86954 A
Patent document 2: JP 2010-118337 A
Patent document 3: JP 2010-165667 A

### DISCLOSURE OF INVENTION

### Problem to be Solved by the Invention

Though LiCoO₂ is used in general as a positive electrode active material of a non-aqueous secondary battery, from the viewpoint of aiming to increase the capacity further, use of a positive electrode active material of a higher capacity, such as LiNiO₂, is considered. However, LiNiO₂ has a disadvantage that the thermal stability in a charge state is lower than that of LiCoO₂.

In order to cope with the problem, it is also considered to substitute a part of Ni in LiNiO₂ with another element such as Co and Mn for the purpose of increasing the thermal stability. However, in a battery using such a positive electrode active material, the element such as Co and Mn easily will elute into the non-aqueous electrolyte due to an irreversible redox reaction at the positive electrode. Ions of Co and/or Mn eluting into the non-aqueous electrolyte are precipitated as Co and Mn on the negative electrode surface so as to degrade the negative electrode and cause deterioration of the charge/discharge cycle characteristics of the battery or react at the negative electrode so as to generate a gas to swell the battery, thereby resulting in deterioration of the storage characteristics of the battery.

Furthermore, into a lithium-containing composite oxide where a part of Ni in LiNiO₂ has been substituted with another element, alkalis such as lithium hydroxide and lithium carbonate as impurities during a synthesis will get mixed easily. The alkali in the lithium-containing composite oxide similarly causes deterioration of the storage characteristics of the battery by for example reacting with the non-aqueous electrolyte within the battery so as to generate a gas and swell the battery. Further, a reaction product of the reaction between the alkali and the non-aqueous electrolyte is deposited on the electrode surface so as to cause deterioration of the charge/discharge cycle characteristics of the battery.

Due to the situation, development of techniques for improving the charge/discharge cycle characteristics and storage characteristics of a non-aqueous secondary battery using a positive electrode active material of the lithium-containing composite oxide that contains Ni has been required.

Therefore, with the foregoing in mind, the present invention provides a non-aqueous secondary battery exhibiting excellent charge/discharge cycle characteristics and excellent storage characteristics while using a lithium-containing composite oxide that contains Ni.

### Means for Solving Problem

A non-aqueous secondary battery of the present invention is a non-aqueous secondary battery including a positive electrode, a negative electrode, a separator and a non-aqueous electrolyte. In the non-aqueous secondary battery, the positive electrode includes a lithium-containing composite oxide as a positive electrode active material, and the lithium-containing composite oxide is expressed by a general compositional formula (1) below:

Li_{1+y}MO₂ (1).

In the general compositional formula (1), −0.5≦y≦0.5, and M denotes an element group including Ni and at least one element selected from the group consisting of Co, Mn, Fe and Ti. When the percentages of the element number of Ni, Co, Mn, Fe and Ti included in the element group M are denoted as a (mol %), b (mol %), c (mol %), d (mol %) and e(mol %) respectively, 30≦a≦95, b≦40, c≦40, d≦30, e≦30 and 5≦b+c+e≦60, and
the non-aqueous electrolyte includes a cycloalkane derivative A having at least one alkyl ether group containing an unsaturated bond, and at least one compound selected from the group consisting of an azacrown ether compound B having a functional group where at least one of nitrogen atoms contains an unsaturated bond and a nitrogen-containing heterocyclic compound C.

### Effects of the Invention

According to the present invention, it is possible to provide a non-aqueous secondary battery that exhibits excellent charge/discharge cycle characteristics and excellent storage characteristics while using a lithium-containing composite oxide that contains Ni.

### BRIEF DESCRIPTION OF DRAWINGS

FIG. 1A is a plan view showing an example of a non-aqueous secondary battery of the present invention, and FIG. 1B is a cross-sectional view of FIG. 1A.

FIG. 2 is a perspective view showing an example of a non-aqueous secondary battery of the present invention.

### DESCRIPTION OF THE INVENTION

A non-aqueous secondary battery of the present invention includes a positive electrode, a negative electrode, a separator and a non-aqueous electrolyte. The positive electrode includes a lithium-containing composite oxide as a positive electrode active material. The lithium-containing composite oxide is expressed by a general compositional formula (1) below:

Li_{1+y}MO₂ (1).

In the general compositional formula (1), −0.5≦y≦0.5, and M denotes an element group including Ni and at least one element selected from the group consisting of Co, Mn, Fe and Ti. When the contents of the element number of Ni, Co, Mn, Fe and Ti included in the element group M are denoted as a (mol %), b (mol %), c (mol %), d (mol %) and e (mol %) respectively, 30≦a≦95, b≦40, c≦40, d≦30, e≦30 and 5≦b+c+d+e≦60. And the non-aqueous electrolyte includes a cycloalkane derivative A having at least one alkyl ether group containing an unsaturated bond, and at least one compound selected from the group consisting of an azacrown ether compound B having a functional group where at least one of nitrogen atoms contains an unsaturated bond and a nitrogen-containing heterocyclic compound C.

Due to the above-described configuration, the non-aqueous secondary battery of the present invention can exhibit high charge/discharge cycle characteristics and high storage characteristics even when a lithium-containing composite oxide that contains Ni is used.

Hereinafter, the configuration of the non-aqueous secondary battery of the present invention will be explained.

<Positive Electrode>

A positive electrode of a non-aqueous secondary battery according to the present invention includes a positive electrode material mixture layer formed on at least one side of a current collector, and the positive electrode material mixture layer contains a positive electrode active material, a binder, a conductive assistant and the like.

For the positive electrode active material, at least a lithium-containing composite oxide expressed by the above-described general compositional formula (1) is used. The Ni is a component that contributes to the improvement in capacity of the lithium-containing composite oxide expressed by the general compositional formula (1).

In the general compositional formula (1) expressing the lithium-containing composite oxide, when the total number of elements of the element group M is 100 mol %, the percentage a of Ni is 30 mol % or more from the viewpoint of improving the capacity of the lithium-containing composite oxide. However, if the ratio of Ni in the lithium-containing composite oxide is too large, Ni will be introduced into an Li site thereby easily becoming a nonstoichiometric composition, or the average valence of Ni is lowered. This will lower the capacity or cause a loss of reversibility. Therefore, in the general compositional formula (1) expressing the lithium-containing composite oxide, when the total number of elements of the element group M is 100 mol %, the percentage a of Ni is set to 95 mol % or less.

The element group M of the lithium-containing composite oxide expressed by the general compositional formula (1) contains further at least one element selected from the group consisting of Co, Mn, Fe and Ti.

In a case where the total number of elements of the element group M is 100 mol % in the general compositional formula (1) expressing the lithium-containing composite oxide, when Co is present in the crystal lattice and when the percentage b of Co is set to 40 mol % or less, it is possible to reduce an irreversible reaction caused by a phase transition of the lithium-containing composite oxide due to insertion and desorption of Li during charge/discharge of the non-aqueous secondary battery, and improve the reversibility of the crystal structure of the lithium-containing composite oxide. As a result, a non-aqueous secondary battery with a long charge/discharge cycle life can be constituted. For securing more favorably the above-described effect provided by the contained Co, preferably the percentage b of Co is set to 3 mol % or more when the total number of elements of the element group M is 100 mol % in the general compositional formula (1) expressing the lithium-containing composite oxide.

In a case where the total number of elements of the element group M in the general compositional formula (1) expressing the lithium-containing composite oxide is 100 mol %, when Mn is present in the crystal lattice and when the percentage c of Mn is set to 40 mol % or less, the Mn functions together with the bivalent Ni to stabilize the layer structure. Since this also can improve the thermal stability of the lithium-containing composite oxide, a safer non-aqueous secondary battery can be configured. For securing more favorably the effect provided by the contained Mn, in the general compositional formula (1) expressing the lithium-containing composite oxide, preferably the percentage c of Mn is set to 1 mol % or more when the total number of elements of the element group M is 100 mol %.

In a case where the total number of elements of the element group M in the general compositional formula (1) expressing the lithium-containing composite oxide is set to 100 mol %, when Fe is contained in the lithium-containing composite oxide and when the percentage dof Fe is set to 30 mol % or less, the crystal structure is stabilized and the thermal stability can be improved. Further, since a composite compound where Ni and Fe are mixed uniformly is used as the raw material for synthesizing the lithium-containing composite oxide, it is also possible to increase the capacity. For securing more favorably the effect provided by the contained Fe, in a case where the total number of elements of the element group M in the general compositional formula (1) expressing the lithium-containing composite oxide is 100 mol %, preferably the percentage dof Fe is set to 0.1 mol % or more.

Further in a case where the total number of elements of the element group M in the general compositional formula (1) expressing the lithium-containing composite oxide is 100 mol %, when Ti is contained in the lithium-containing composite oxide and when the percentage e of Ti is set to 30 mol % or less, Ti is incorporated in crystal defect sites due to oxygen deficiency or the like in the LiNiO₂ type crystal structure and stabilizes the crystal structure, increasing the reversibility in the reaction of the lithium-containing complex oxide and it is therefore possible to obtain a lithium-containing complex oxide having excellent charge/discharge cycle characteristics. Further, since a composite compound where Ni and Ti are mixed uniformly is used as the raw material for synthesizing the lithium-containing composite oxide, it is also possible to increase the capacity. For securing more favorably the effect provided by the contained Ti, in a case where the total number of elements of the element group M in the general compositional formula (1) expressing the lithium-containing composite oxide is 100 mol %, preferably the percentage e of Ti is set to 0.1 mol % or more.

The element group M in the lithium-containing composite oxide is not limited in particular as long as it contains Ni and any one element selected from the group consisting of Co, Mn, Fe and Ti. Or it may contain Ni and two or more elements selected from the group consisting of Co, Mn, Fe and Ti.

And in a case where the total number of elements of the element group M in the general compositional formula (1) expressing the lithium-containing composite oxide is 100 mol %, the sum of the percentage b of Co, the percentage cof Mn, the percentage dof Fe and the percentage e of Ti is not limited particularly as long as it is not less than 5 mol % and not more than 60 mol %.

Further, the element group M in the lithium-containing composite oxide may contain elements other than Ni, Co, Mn, Fe and Ti. Examples of such elements include group IIA elements such as Mg, Sr and Ba; and group IIIB elements such as B, Al and Ga.

The above-described group IIA elements and group IIIB elements other than Ni, Co, Mn, Fe and Ti are regarded typically as additional elements in the lithium-containing composite oxide. The elements serve to stabilize the crystal structure and control reactivity, but excessive contents thereof may lower the capacity. Therefore, when the total number of elements of the element group M is 100 mol %, it is preferable that the percentage of the elements other than Ni, Co, Mn, Fe and Ti is 20 mol % or less, and more preferably, 10 mol % or less. The elements other than Ni, Mn, Fe and Ti in the element group M may be distributed uniformly in the lithium-containing composite oxide, or they may be segregated on particle surfaces or the like.

The lithium-containing composite oxide having the above-described composition has a true density as large as 4.55 g/cm³ or more and 4.95 g/cm³ or less, and thus is a material having a high volume energy density. This is presumably because the true density of the lithium-containing composite oxide containing Mn within a predetermined range changes significantly according to the composition of the lithium-containing composite oxide, but with a narrow composition range as described above, a stable synthesis is available, and thus the true density takes a large value as described above. Also in the lithium-containing complex oxide having the above-described composition, the capacity per mass of the lithium-containing composite oxide can be increased, and a material having excellent reversibility can be obtained.

The lithium-containing composite oxide has a large true density particularly when it has a composition close to the stoichiometric ratio. Specifically, in the general compositional formula (1), xpreferably is within the range of −0.5≦x≦0.5. By adjusting the value of xwithin this range, increased true density and reversibility can be obtained. More preferably, x is −0.1 or more and 0.3 or less. In this case, the lithium-containing composite oxide can have a true density as high as 4.4 g/cm³ or more.

In order to obtain a higher capacity in the lithium-containing composite oxide expressed by the general compositional formula (1), it is preferable that y>0, namely, the amount of Li is greater than the total amount of the element group M. Since a more stable lithium-containing composite oxide can be synthesized with such a composition, the capacity of discharging with respect to charging can be enhanced, and thus a higher capacity will be obtainable.

The lithium-containing composite oxide expressed by the general compositional formula (1) includes a comparatively large amount of Ni as described above, and thus it includes a great amount of alkali, i.e., 0.1 mass % or more (alkali residing as impurities at the time of synthesis). In the battery of the present invention, by including the below-mentioned non-aqueous electrolyte, deterioration of the charge/discharge cycle characteristics and the storage characteristics of the battery caused by the alkali can be inhibited favorably. In particular, when y>0, the Li amount in the lithium-containing composite oxide is excessive, and the alkali amount in the lithium-containing composite oxide is increased. The battery of the present invention can inhibit favorably deterioration of the charge/discharge cycle characteristics and the storage characteristics even in the case of using the lithium-containing composite oxide as the positive electrode active material.

The lithium-containing composite oxide represented by the general compositional formula (1) can be synthesized by, for example, mixing a Li-containing compound and a Ni-containing compound, and further any of a Co-containing compound, a Mn-containing compound, a Fe-containing compound, a Ti-containing compound and the like as required, and firing the mixture. In order to synthesize the lithium-containing composite oxide with a higher purity, for example, it is preferable to use a composite compound including Ni and at least one element included in the element group M other than Ni (examples of such a compound are: a coprecipitation compound including these elements, a hydrothermally-synthesized compound, a mechanically-synthesized compound, and a compound obtained by treating them with heat). For these composite compounds, hydroxides and oxides including the above-described elements are preferred.

In the synthesis of the lithium-containing composite oxide, the conditions for firing the raw materials such as a mixture of raw compounds and a composite compound are: the temperature is 600 to 1000° C. and the time is 1 to 24 hours, for example.

In firing the raw materials such as the raw material mixture and the composite compound, rather than warming at one breath to a predetermined temperature, it is preferable to preheat by heating to a temperature lower than the firing temperature (for example, 250 to 850° C.) and by retaining at the temperature for about 0.5 to 30 hours, and thereafter warming to the firing temperature to proceed the reaction. It is also preferable to keep the oxygen concentration constant in the firing atmosphere. Thereby, the homogeneity of the composition of the lithium-containing composite oxide can be improved further.

The atmosphere for firing of the raw materials such as the above-described raw material mixture and the composite compound can be an atmosphere including oxygen (namely, air), an atmosphere of mixture of an inert gas (argon, helium, nitrogen and the like) and an oxygen gas, an oxygen gas atmosphere and the like. The oxygen concentration (on the volumetric basis) is preferably not less than 15%, and more preferably not less than 18%. In order to reduce the production cost of the lithium-containing composite oxide and to improve the productivity of the lithium-containing composite oxide as well as the productivity of the battery, it is more preferable that the raw material is fired in the atmospheric flow.

The flow rate of the gas in the firing of the raw material is preferably 2 dm³/min or more per 100 g of the raw material. If the flow rate of the gas is too small, i.e., if the gas flow velocity is too slow, the homogeneity of the composition of the lithium-containing composite oxide may be impaired. Moreover, the flow rate of the gas in the firing of the raw material is preferably 5 dm³/min or less per 100 g of the raw material.

In the step of firing the raw materials, a dry-mixed material (which may contain a composite compound) may be used directly. Alternatively, it is preferable that the mixture of the raw materials or the composite compound is dispersed in a solvent such as ethanol to make slurry, which is mixed in a planetary ball mill or the like for about 30 to 60 minutes, and dried to be used. This method can further improve the homogeneity of the lithium-containing composite oxide to be synthesized.

Since the surface activity of the particles of the lithium-containing composite oxide expressed by the general compositional formula (1) is suppressed appropriately, the gas generation within the battery can be inhibited more effectively, and particularly in a case of providing a battery having a square (i.e., rectangular cylindrical) outer case (i.e., angular battery), the outer case is not likely to be deformed, so that the storage characteristics and life of the battery can be improved. Specifically, it is preferable that in the lithium-containing composite oxide expressed by the general compositional formula (1), the percentage of the primary particles having a particle size of not more than 1 μm is 30 volume % or less, and more preferably, 15 volume % or less. Further, it is preferable in the lithium-containing composite oxide expressed by the general compositional formula (1), the BET specific surface area is 0.3 m²/g or less, and more preferably 0.25 m²/g or less.

In other words, regarding the lithium-containing composite oxide, in a case where the percentage of primary particles having a particle size of not more than 1 μm and/or the BET specific surface area is within the above-described range among the whole primary particles, it is possible to suppress to a degree the reaction surface area to decrease the active sites and to further hinder irreversible reactions with the atmospheric moisture, the binder used for formation of the positive electrode material mixture layer and the non-aqueous electrolyte, thereby suppressing more effectively gas generation within the battery. Furthermore, it is possible to inhibit effectively gelation of composition (paste, slurry and the like) that includes a solvent to be used for formation of the positive electrode material mixture layer.

The lithium-containing composite oxide may contain no primary particles having a particle size of 1 μm or less (in other words, the percentage of primary particles having a particle size of 1 μm or less may be 0 volume %). The BET specific surface area of the lithium-containing composite oxide is preferably 0.1 m²/g or more in order to prevent the reactivity from deteriorating more than necessary. Furthermore, the lithium-containing composite oxide preferably has a number average particle size of 5 to 25 μm.

The percentage of primary particles having a particle size of 1 μm or less contained in the lithium-containing composite oxide according to the present Specification and the number average particle size of the lithium-containing composite oxide (furthermore the number average particle size of another active material, which will be described later) can be measured by using a laser diffraction/scattering particle size distribution analyzer such as “Microtrac HRA” available from Nikkiso Co. Ltd. The BET specific surface area of the lithium-containing composite oxide is a specific surface area of the surface and micropores of the active material obtained by measuring the surface area and performing calculation by the BET method, which is a theory for multilayer adsorption. Specifically, the BET specific surface area is a value obtained using a specific surface area measuring apparatus that uses nitrogen adsorption method (“Macsorb HM model-1201” available from Mountech Co., Ltd.).

The lithium-containing composite oxide expressed by the general compositional formula (1) can have the above-described configurations (in the percentage of primary particles having a particle size of 1 μm or less; number average particle size; and BET specific surface area), and these shapes can be adjusted by filtering or the like as required.

While the positive electrode of the battery of the present invention has a positive electrode material mixture layer containing as an active material the lithium-containing composite oxide expressed by the general compositional formula (1), the positive electrode material mixture layer may include also other active material(s). Examples of the applicable active materials other than the lithium-containing composite oxide expressed by the general compositional formula (1) include: lithium cobalt oxides such as LiCoO₂; lithium-manganese oxides such as LiMnO₂ and Li₂MnO₃; lithium-containing composite oxides having a spinel structure such as LiMn₂O₄ and Li_{4/3}Ti_{5/3}O₄; lithium-containing composite oxides having an olivine structure such as LiFePO₄; and oxides based on any of the above-described oxides where a part of the constituent elements is substituted with another element.

In a case of using in combination the lithium-containing composite oxide expressed by the general compositional formula (1) and any other active material, these materials may be mixed simply and used, but it is further preferable that these particles are used as composite particles integrated by pelletization or the like. In such a case, the packing density of the active material in the positive electrode material mixture layer can be improved and the contacts between the active material particles can be secured further. As a result, it is possible to further enhance the battery capacity and the load characteristics.

In a case of the composite particles of the lithium-containing complex oxide expressed by the general compositional formula (1) and another active material, it is preferable that the number average particle size of either material is not more than a half of the other. This indicates that if composite particles are formed by combining particles of a large number average particle size (hereinafter this is recited as “large particles”) and particles of a small number average particle size (hereinafter this is recited as “small particles”), the small particles easily will be dispersed and fixed around the large particles, thereby composite particles of more homogeneous mixing ratio can be formed. As a result, non-uniform reaction in the positive electrode can be suppressed and thus, the charge/discharge cycle characteristics and the safety of the battery can be enhanced further.

It is also possible to add a binder or a conductive assistant to the active material for the purpose of forming the composite particles.

For the binder, any of a thermoplastic resin and a thermosetting resin may be used as long as it is chemically stable within the battery. The examples include: polyethylene, polypropylene, polytetrafluoroethylene (PTFE), polyvinylidene fluoride (PVDF), polyhexafluoropropylene (PHFP), styrene-butadiene rubber, tetrafluoroethylene-hexafluoroethylene copolymer, tetrafluoroethylene-hexafluoropropylene copolymer (FEP), tetrafluoroethylene-perfluoro alkyl vinyl ether copolymer (PFA), vinylidene floride-hexafluoropropylene copolymer, vinylidene fluoride-chlorotrifluoroethylene copolymer, ethylene-tetrafluoroethylene copolymer (ETFE resin), polychlorotrifluoroethylene (PCTFE), vinylidene fluoride-pentafluoro propylene copolymer, propylene-tetrafluoroethylene copolymer (PPTFE), ethylene-chlorotrifluoroethylene copolymer (ECTFE), vinylidene fluoride-hexafluoropropylene-tetrafluoroethylene copolymer, vinylidene fluoride-perfluoromethyl vinyl ether-tetrafluoroethylene copolymer; or ethylene-acrylic acid copolymer, ethylene-methacrylic acid copolymer, ethylene-methyl acrylate copolymer, ethylene-methyl methacrylate copolymer and crosslinked substances of theses copolymers. They may be used alone or in combination of two or more. Among them, from the viewpoint of the stability within the battery or the characteristics of the battery, PVDF, PTFE, PHFP, and PPTFE are preferred. Also it is possible to use them in combination or use a copolymer formed from these monomers.

For the conductive assistant, any substance that is chemically stable in the battery can be used. The examples include: graphites such as natural graphite and artificial graphite; carbon blacks such as acetylene black, Ketjen Black (trade name), channel black, furnace black, lamp black and thermal black; conductive fibers such as carbon fiber (vapor-grown carbon fiber, carbon nanotube and the like), and metallic fiber; metallic powder such as aluminum powder; carbon fluoride; zinc oxide; conductive whisker made of potassium titanate or the like; conductive metallic oxides such as titanium oxide; and organic conductive materials such as polyphenylene derivative. They may be used alone or in combination of two or more. Among them, highly-conductive graphite, carbon black having excellent liquid absorption, carbon fiber (especially vapor-grown carbon fiber) that can form more effectively the conductive path between the positive electrode active material particles are preferred for example. The shape of the conductive assistant is not limited to the primary particles, but secondary aggregates and also an aggregate such as chain structure can be used. These aggregates can be handled easily and thus the productivity is improved.

The positive electrode material mixture layer of the positive electrode can be formed in the following manner. For example, the lithium-containing composite oxide or any other active material used as required or the composite particles, and further the binder, and the conductive assistant are added to a solvent so as to prepare a positive electrode material mixture containing composition in the form of a paste or slurry. This composition is applied to the surface of the current collector by various coating methods, dried, and then subjected to the pressing process so as to adjust the thickness and density of the positive electrode material mixture layer. The positive electrode is not limited to the one obtained by forming the positive electrode material mixture layer by the above-described methods, but it may be produced by other methods.

The method for coating the surface of the current collector with the positive electrode material mixture containing composition may be: e.g., a substrate-lifting method using a doctor blade; a coater method using a die coater, a comma coater, or a knife coater; or a printing method such as screen printing or relief printing.

The binder and the conductive assistant that can be used for the preparation of the positive electrode material mixture containing composition may be the various binders and various conductive assistants that can be used for the formation of the composite particles. For the same reason as described above, PVDF, PTFE, PHFP and PPTFE are preferred for the binder. And graphite, carbon black and carbon fiber (especially vapor-grown carbon fiber) are preferred for the conductive assistant.

In the positive electrode material mixture layer, it is preferable that the whole active materials including the lithium-containing composite oxide expressed by the general compositional formula (1) is 80 to 99 mass %, the binder (including the binder contained in the composite particles) is 0.5 to 10 mass %, and the conductive assistant (including the conductive assistant contained in the composite particles) is 0.5 to 10 mass %.

The thickness of the positive electrode material mixture layer formed on each side of the current collector is preferably 15 to 200 μm after pressing. Moreover, the density of the positive electrode material mixture layer is preferably 2.0 g/cm³ or more after pressing. By using the positive electrode including the positive electrode material mixture layer of high density, a battery of a higher capacity can be constituted. However, if the density of the positive electrode material mixture layer is too large, the porosity is reduced, and thus may lead to low permeability for the non-aqueous electrolyte. Therefore, the density of the positive electrode material mixture layer is preferably 4.5 g/cm³ or less after pressing. In the press process, e.g., roll pressing can be performed with a linear pressure of about 1 to 100 kN/cm, thereby providing the positive electrode material mixture layer having the above-described density.

The density of the positive electrode material mixture layer in the context of the present specification is a value measured by the following manner. First, the positive electrode is cut into a sample having a predetermined area, and the mass of the sample is measured by an electronic force balance with a minimum scale of 0.1 mg. Then, the mass of the current collector is subtracted from the mass of the sample, yielding the mass of the positive electrode material mixture layer. On the other hand, the total thickness of the positive electrode was measured at 10 points by a micrometer with a minimum scale of 1 μm, and the volume of the positive electrode material mixture layer is calculated from the area and the average of the values obtained by subtracting the thickness of the current collector from the measured values. The density of the positive electrode material mixture layer is determined by dividing the mass by the volume of the positive electrode material mixture layer.

The material for the current collector of the positive electrode is not particularly limited as long as it is an electronic conductor that is chemically stable in the battery. Examples of the material include: aluminum or aluminum alloy; stainless steel; nickel; titanium; carbon; a conductive resin; and a composite material obtained by forming a carbon layer or a titanium layer on the surface of aluminum, aluminum alloy, or stainless steel. Among these, the aluminum or aluminum alloy is particularly preferred because they are lightweight and have high electronic conductivity. The current collector of the positive electrode may be, e.g., a foil, a film, a sheet, a net, a punching sheet, a lath, a porous body, a foam body, or a compact of a fibrous material, which are made of the above materials. Moreover, the current collector may be subjected to a surface treatment to make the surface uneven. The thickness of the current collector is not particularly limited and generally can be 1 to 500 μm.

In the positive electrode, a lead connector may be formed by a conventional method so as to make an electric connection to the other members in the battery

<Non-Aqueous Electrolyte>

For the non-aqueous electrolyte for the battery of the present invention, a solution prepared by dissolving lithium salt in an organic solvent (non-aqueous electrolyte solution) is used. In the non-aqueous electrolyte in the present invention, a cycloalkane derivative A having at least one alkyl ether group containing an unsaturated bond [hereinafter, this may be referred to as “compound A”] and either an azacrown ether compound B where at least one of the nitrogen atoms contains an unsaturated bond [hereinafter, this may be referred to as “compound B”] or a nitrogen-containing heterocyclic compound C [hereinafter, this may be referred to as “compound C”] are contained.

In the battery of the present invention, by using the non-aqueous electrolyte as described above, for example even when the lithium-containing composite oxide expressed by the general compositional formula (1) where the alkali content can be 0.1 mass % or more is used for the positive electrode active material, deterioration of the charge/discharge cycle characteristics and the storage characteristics caused by elution of these alkali and/or the metal in the positive electrode active material can be inhibited effectively. Though the detailed mechanism of the effect provided by the battery of the present invention has not been clarified yet, the inventors deduce as follows from the physical properties of the compound A, compound B and compound C and also from the test result.

The cycloalkane derivative A having at least one alkyl ether group containing an unsaturated bond forms a film on the surface of the positive electrode within the battery. The azacrown ether compound B having a functional group where at least one of the nitrogen atoms has an unsaturated bond forms a film on the surface of the negative electrode within the battery. Further, the nitrogen-containing heterocyclic compound C is considered as having an action of trapping hydrofluoric acid (HF) and a cation.

It is considered that the film derived from the compound A formed on the positive electrode surface within the battery serves to inhibit the reaction between the non-aqueous electrolyte and the positive electrode active material [the lithium-containing composite oxide expressed by the general compositional formula (1)] and alkali as the impurity. Therefore, gas generation and deposition of the reaction product on the electrode surface due to the reaction is suppressed, and thus deterioration of the charge/discharge cycle characteristics and the storage characteristics of the battery is inhibited.

It is also considered that the film derived from the compound B formed on the negative electrode surface within the battery serves to inhibit the reaction between the negative electrode and the metallic ion eluted from the positive electrode active material. Therefore, gas generation caused by the reaction is suppressed, and thus deterioration of the charge/discharge cycle characteristics and the storage characteristics of the battery is inhibited.

As mentioned below, it is also possible to add any additive other than the compound A, the compound B and the compound C to the non-aqueous electrolyte, and the additive is capable of forming a film on the electrode surface (e.g., the negative electrode surface). However, such a film formed on the negative electrode surface by the additive will be destroyed easily due to a contact with a metallic ion eluted from the positive electrode active material. By forming a film derived from the compound B on the negative electrode surface, destruction of the film formed by the additive is suppressed, and the action can be exhibited effectively.

In the non-aqueous electrolyte, HF derived from the lithium salt may exist or HF may be formed due to decomposition of the lithium salt or the binder used in the material mixture layer of the positive and/or negative electrode, and this HF will react with the alkali as the impurity in the positive electrode active material thereby generating a gas. However, as the compound C exists in the non-aqueous electrolyte, the HF is trapped and thus gas generation will be suppressed. Further, since the metallic ion eluted from the positive electrode active material is trapped also by the compound C, also degradation of the negative electrode and gas generation caused thereby will be suppressed. As a result, deterioration of the charge/discharge cycle characteristics and the storage characteristics of the battery due to the gas generation and the degradation of the negative electrode will be inhibited.

The non-aqueous electrolyte of the present invention is not limited particularly as long as it contains the compound A and either the compound B or the compound C. Preferably it contains all of the compound A, the compound B and the compound C.

In a case where the non-aqueous electrolyte contains the compound A only but it does not contain the compound B and the compound C, the non-aqueous electrolyte (non-aqueous electrolyte solution) will be thickened. In such a case, for example, at the time of assembling the battery, injection of the non-aqueous electrolyte into an outer case will be difficult or impossible. Or permeation into the electrode will be delayed and become heterogeneous. As a result, the electrochemical reaction will be non-uniform and the charge/discharge cycle characteristics and the storage characteristics of the battery may deteriorate. That is, the compound B and the compound C have also an action of suppressing thickening of the non-aqueous electrolyte containing the compound A.

In a case where the non-aqueous electrolyte contains the compound B and compound C but does not contain the compound A, the compound B and the compound C will be decomposed at the positive electrode, and thus the above-described effect provided by these compounds is not exhibited favorably. That is, the compound A has also an action of inhibiting decomposition of the compound B and the compound C at the positive electrode.

Examples of the cycloalkane derivative A having at least one alkyl ether group containing an unsaturated bond include: cyclopentyl propenyl ether, cyclopentyl vinyl ether, cyclohexyl propenyl ether, cyclohexyl vinyl ether, cycloheptyl propenyl ether, cycloheptyl vinyl ether; and, alkenoxy methyl cycloalkanes; and alkenoxy ethyl cycloalkanes. They may be used alone or in combination of two or more.

Examples of the alkenoxy methyl cycloalkanes include: (cyclohexylmethyl) propenyl ether, (cyclohexylmethyl) vinyl ether, 1,2-bis(propenoxymethyl)cyclopentane, 1,3-bis(propenoxymethyl)cyclopentane, 1,2,4-tris(vinyloxymethyl)cyclopentane, 1,2-bis(vinyloxymethyl)cyclopentane, 1,3-bis(vinyloxymethyl)cyclopentane, 1,2,4-tris(vinyloxymethyl)cyclopentane, cyclohexyl propenyl ether, 1,2-bis(propenoxymethyl)cyclohexane, 1,3-bis(propenoxymethyl)cyclohexane, 1,4-bis(propenoxymethyl)cyclohexane, 1,3,5-tris(propenoxymethyl)cyclohexane, 1,2-bis(vinyloxymethyl)cyclohexane, 1,3-bis(vinyloxymethyl)cyclohexane, 1,4-bis(vinyloxymethyl)cyclohexane, 1,3,5-tris(vinyloxymethyl)cyclohexane, 1,2-bis(propenoxymethyl)cycloheptane, 1,3-bis(propenoxymethyl)cycloheptane, 1,4-bis(propenoxymethyl)cycloheptane, 1,2,4-tris(propenoxymethyl)cycloheptane, 1,3,5-tris(propenoxymethyl)cycloheptane, 1,2-bis(vinyloxymethyl)cycloheptane, 1,3-bis(vinyloxymethyl)cycloheptane, 1,2,4-tris(vinyloxymethyl)cycloheptane, and 1,3,5-tris(vinyloxymethyl)cycloheptane.

Examples of the alkenoxy ethyl cycloalkanes include: (cyclohexylethyl)propenyl ether, (cyclohexylethyl)vinyl ether, 1,3-bis(propenoxyethyl)cycloheptane, 1,3-bis(vinyloxyethyl)cycloheptane, 1,2-bis(propenoxyethyl)cyclohexane, 1,3-bis(propenoxyethyl)cyclohexane, 1,4-bis(propenoxyethyl)cyclohexane, 1,3,5-tris(propenoxyethyl)cyclohexane, 1,2-bis(vinyloxyethyl)cyclohexane, 1,3-bis(vinyloxyethyl)cyclohexane, 1,4-bis(vinyloxyethyl)cyclohexane, and 1,3,5-tris(vinyloxyethyl)cyclohexane.

Among the above recited examples of compound A, a compound having two or more alkyl ether groups containing unsaturated bonds is preferred. In that case, a more favorable film can be formed, and furthermore, the reaction between the non-aqueous electrolyte and the positive electrode active material and also the alkali can be controlled to further suppress the gas generation and the deposition of the reaction product on the electrode surface. As a result, deterioration of the charge/discharge cycle characteristics and the storage characteristics of the battery can be inhibited more effectively.

Examples of the azacrown ether skeleton of the azacrown ether compound B having a functional group where at least one of the nitrogen atoms has an unsaturated bond include: aza-9-crown-3-ether, aza-12-crown-4-ether, aza-15-crown-5-ether, aza-18-crown-6-ether, aza-21-crown-7-ether, aza-24-crown-8-ether, aza-2,3-benzo-9-crown-3-ether, aza-2,3-benzo-12-crown-4-ether, aza-2,3,11,12-dibenzo-15-crown-5-ether, aza-2,3,8,9-dibenzo-18-crown-6-ether, aza-5,6,11,12,17,18-tribenzo-21-crown-7-ether, and aza-5,6,14,15,20,21-tribenzo-24-crown-8-ether. Among them, an azacrown ether skeleton including a plurality of nitrogen atoms is more preferable, and the examples include: 1,7-diaza-12-crown-4-ether, 1,7-diaza-15-crown-5-ether, 1,10-diaza-18-crown-6-ether, and 1,7,13-triaza-18-crown-6-ether.

In the azacrown ether compound B having a functional group where at least one of the nitrogen atoms contains an unsaturated bond, it is preferable that the functional group containing the unsaturated bond is at least one functional group selected from the group consisting of the functional group expressed by the general structural formula (1) below and (meth)acryloyl alkyl group (acryloyl alkyl group and methacryloyl alkyl group).

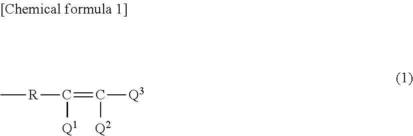

In the general structural formula (1), R denotes alkylene having a carbon number in the range of 1 to 3, Q¹, Q² and Q³ independently denote a hydrogen atom, a fluorine atom, an alkyl group having a carbon number in the range of 1 to 3, a fluoroalkyl group having a carbon number in the range of 1 to 2, a cyano group, a carboxyl group, a carboxyalkyl group having a carbon number in the range of 3 to 5, an alkoxy group having a carbon number in the range of 1 to 3, an alkoxy carbonyl group having a carbon number in the range of 2 to 4, and an alkylene alkyl carbonate group having a carbon number in the range of 3 to 5.

Examples of R (alkylene having a carbon number in the range of 1 to 3) in the general structural formula (1) above include methylene, ethylene, 1,2-propylene and 1,3-propylene. Among them, methylene and ethylene are preferred from the viewpoint of compatibility with the non-aqueous electrolyte solvent.

In a case where the Q¹, Q² and Q³ in the general structural formula (1) are alkyl groups having a carbon number in the range of 1 to 3, examples of the Q¹, Q² and Q³ include a methyl group, an ethyl group, a n-propyl group, and an isopropyl group.

In a case where the Q¹, Q² and Q³ in the general structural formula (1) are fluoroalkyl groups having a carbon number in the range of 1 to 2, preferably the Q¹, Q² and Q³ are groups where 1 to 5 of the hydrogen atoms have been substituted with fluorine atoms. The specific examples include: a fluoromethyl group, a difluoromethyl group, a trifluoromethyl group, a fluoroethyl group, a difluoroethyl group, a trifluoroethyl group, a tetrafluoroethyl group, and a pentafluoroethyl group.

In a case where the Q¹, Q² and Q³ in the general structural formula (1) are carboxyalkyl group having a carbon number in the range of 3 to 5, examples of the Q¹, Q² and Q³ include a carboxymethyl group, a carboxyethyl group, a carboxy-n-propyl group, and a carboxylsopropyl group.

In a case where the Q¹, Q² and Q³ in the general structural formula (1) are alkoxy groups having a carbon number in the range of 1 to 3, preferably the Q¹, Q² and Q³ are alkoxy groups having a carbon number in the range of 1 to 3, specifically for example, a methoxy group, an ethoxy group, a n-propoxy group, and an isopropoxy group.

In a case where the Q¹, Q² and Q³ in the general structural formula (1) are alkoxy carbonyl groups having a carbon number in the range of 2 to 4, preferably the Q¹, Q² and Q³ are alkoxy groups having a carbon number in the range of 1 to 3, specifically for example, a methoxy carbonyl group, an ethoxy carbonyl group, a n-propoxy carbonyl group and an isopropoxy carbonyl group.

In a case where the Q¹, Q² and Q³ in the general structural formula (1) are alkylene alkyl carbonate groups having a carbon number in the range of 3 to 5, examples of the Q¹, Q² and Q³ include a methylene methyl carbonate group, and an ethylene methyl carbonate group.

Examples of the alkyl group of the (meth)acryloyl alkyl group include alkyl groups having a carbon number in the range of 1 to 3, such as a methyl group, an ethyl group, a 1,2-propyl group, and a 1,3-propyl group.

If the carbon number in the substituent for Q¹, Q² and Q³ is long or the steric hindrance is great, or the mesomeric effect is great, such a case is inappropriate since the reactivity is poor, and it is impossible to form a favorable film on the negative electrode surface.

Specific examples of the azacrown ether compound B having a functional group where at least one of the nitrogen atoms has an unsaturated bond include: 1,7-bis(butenoic acid)-1,7-diaza-12-crown-4-ether, 1-(2-methyl butenoate)-1-aza-12-crown-4-ether, 1,7-bis(2-methyl butenoate)-1,7-diaza-12-crown-4-ether, 1-(2-methyl butenoate)-1-aza-15-crown-5-ether, 1,7-bis(2-methyl butenoate)-1,7-diaza-15-crown-5-ether, 1,10-bis(2-ethyl butenoate)-1,10-diaza-18-crown-6-ether, 1,7-bis(3-fluoromethyl butenoate)-2,3-benzo-1,7-diaza-15-crown-5-ether, 1,7-bis(3-trifluoromethyl methyl butenoate)-1,7-diaza-15-crown-5-ether, 1,7-bis(1-acryloyl methyl)-1,7-diaza-15-crown-5-ether, 1,4-bis(1-acryloyl ethyl)-1,4-diaza-15-crown-5-ether, 1,7-bis(1-acryloyl ethyl)-1,7-diaza-15-crown-5-ether, 1-(1-acryloyl ethyl)-1-aza-14-crown-4-ether, 1-(2-ethyl pentenoate)-1-aza-18-crown-6-ether, 1,10-bis(2-methyl pentenoate)-1,10-diaza-18-crown-6-ether, and 1,10-bis(2-ethyl pentenoate)-2,3,14,15-dibenzo-1,10-diaza-18-crown-6-ether.

For the compound B, one of the above-described examples may be used alone or in combination of two or more.

Examples of the nitrogen-containing heterocyclic compound C include: pyridines such as pyridine, 2-amino-pyridine, and nicotine; pyrroles such as pyrrole, and 3-amino-pyrrole; quinolines such as quinoline, isoquinoline, 2-amino-quinoline, and 3-amino isoquinoline; imidazoles such as imidazole, 2-amino-1,3-imidazole, and 4-amino-1,3-imidazole; indoles such as indole, and 5-amino-indole; pyrazoles such as pyrazole, 4-amino-1,2-pyrazole, histidine, and histamine; triazoles such as 1,2,3-triazole, 1,3,4-triazole, 1,2,4-triazole, 4-methyl-1,2,3-triazole, 2-amino-1,3,4-triazole, and 3-amino-1,2,4-triazole; pyrimidines such as pyrimidine, 2-amino-1,3-pyrimidine, cytosine, thymine, and thiamine; pyrazines such as pyrazine, and 2-amino-1,4-pyrazine; pyridazines such as pyridazine, and 3-amino-pyridazine; triazines such as triazine, and 2-amino-1,3,6-triazine; purines such as purine, adenine, guanine, caffeine, theobromine, xanthine, uric acid, and the derivatives; porphin; heme; and chlorophyll. These are considered as having a trap action due to the coordination of a proton and/or a metal cation at the lone pair of nitrogen. Therefore, the compound C is not limited to the above examples as long as it is a compound that includes a hetero cycle containing a nitrogen atom and that has the above-described action.

Among the above-described examples, preferably the compound C has at least two nitrogen atoms within the molecule. It is particularly preferable that the compound C has the nitrogen atoms in one ring, and the specific examples of the preferred compound C include the above-described imidazoles, pyrazoles, triazoles, pyrimidines, and triazines. In the compound C having at least two nitrogen atoms in the molecule [particularly preferably the compound C having the nitrogen atoms in one ring], these nitrogen atoms allow molecular rearrangement, thereby the coordination compound formed by trapping metallic ions and HF can be stabilized, and thus the action is exhibited in a particularly favorable manner.

For the compound C, one of the above-described examples may be used alone or in combination of two or more.

Preferably, the content of the compound A in the non-aqueous electrolyte used for the battery [which is the content in the whole amount of the non-aqueous electrolyte; this is applied similarly to the compound A, the compound B, the compound C, and various additives mentioned below unless otherwise specified particularly] is not less than 0.01 mass %, and more preferably, not less than 0.1 mass % from the viewpoint of favorably securing the above-described effect provided by the application. It should be noted however, when the amount of the compound A in the non-aqueous electrolyte is excessive, the viscosity of the non-aqueous electrolyte increases excessively, and/or the film to be formed on the positive electrode becomes too thick, which may degrade the load characteristics of the battery. Therefore, it is preferable that the content of the compound A in the non-aqueous electrolyte used for the battery is not more than 5 mass %, and more preferably not more than 2 mass %.

It is also preferable that the content of the compound B in the non-aqueous electrolyte used for the battery is not less than 0.02 mass %, and more preferably, not less than 0.1 mass %, from the viewpoint of favorably securing the above-described effect provided by the application. However, when the content of the compound B in the non-aqueous electrolyte is excessive, it will be necessary to increase the use amount of the compound A for the purpose of preventing decomposition at the positive electrode, and it may degrade the load characteristics of the battery as described above. Further, the film to be formed on the negative electrode surface will be so thick to degrade the load characteristics of the battery. Therefore, preferably the content of the compound B in the non-aqueous electrolyte to be used for the battery is not more than 5 mass %, and more preferably, not more than 2 mass %.

It is also preferable that the content of the compound C in the non-aqueous electrolyte used for the battery is not less than 0.01 mass %, and more preferably, not less than 0.1 mass %, from the viewpoint of favorably securing the above-described effect provided by the application. However, when the content of the compound C in the non-aqueous electrolyte is excessive, it will be necessary to increase the use amount of the compound A for the purpose of preventing decomposition at the positive electrode, and it may degrade the load characteristics of the battery as described above. Further, the film to be formed on the negative electrode surface may be unstable and the effect of improving the charge/discharge cycle characteristics of the battery may be decreased. Therefore, preferably the content of the compound C in the non-aqueous electrolyte to be used for the battery is not more than 3 mass %, and more preferably, not more than 1 mass %.

The lithium salt for the non-aqueous electrolyte is not limited in particular as long as it is dissociated in the solvent so as to form Li⁺ ion and rarely causes a side reaction such as decomposition in the range of voltage to be used as the battery. Examples of the lithium salts include inorganic lithium salts such as LiClO₄, LiPF₆, LiBF₄, LiAsF₆, and LiSbF₆; and organic lithium salts such as LiCF₃SO₃, LiCF₃CO₂, Li₂C₂F₄(SO₃)₂, LiN(CF₃SO₂)₂, LiC(CF₃SO₂)₃, LiCₙF₂ₙ₊₁SO₃ (2≦n≦7), and LiN(R_{f}OSO₂)₂ [here, R_{f} is a fluoroalkyl group].

The organic solvent used for the non-aqueous electrolyte is not limited in particular as long as it dissolves the above-described lithium salts and does not cause a side effect such as decomposition in the range of voltage used for the battery. The examples include: cyclic carbonates such as ethylene carbonate, propylene carbonate, butylene carbonate, and vinylene carbonate; chain carbonates such as dimethyl carbonate, diethyl carbonate, and methyl ethyl carbonate; chain esters such as methyl propionate; cyclic esters such as γ-butyrolactone; chain ethers such as dimethoxyethane, diethoxyethane, diethyl ether, diglyme, triglyme, and tetraglyme; cyclic ethers such as 1,3-dioxolane, dioxolane, tetrahydrofuran, and 2-methyl tetrahydrofuran; nitriles such as acetonitrile, propionitrile, and methoxy propionitrile; and sulfites such as ethylene glycol sulfite. They can be used in combination of two or more. For obtaining a battery of more favorable characteristics, it is desirable to use a combination to provide a high conductance, such as a mixed solvent of ethylene carbonate and chain carbonate.

It is preferable that the concentration of the lithium salt in the non-aqueous electrolyte is 0.5 to 1.5 mol/L, and more preferably, 0.9 to 1.25 mol/L.

It is also preferable that the non-aqueous electrolyte contains either a sulfonic acid anhydride or a sulfonate derivative. When the non-aqueous electrolyte containing either the sulfonic acid anhydride or the sulfonate derivative is used, a film derived from these substances are formed on the electrode surface in the battery so as to inhibit an unnecessary reaction between the electrode and the non-aqueous electrolyte, thereby further improving the safety and storage characteristics of the battery (in particular the storage characteristics at high temperature).

A sulfonic acid anhydride expressed by the general structural formula (2) below is preferred, and a sulfonate derivative expressed by the general structural formula (3) below is preferred.

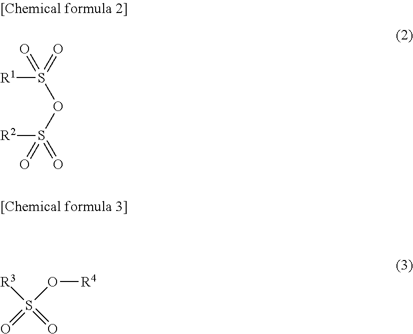

The R¹ and R² in the above general structural formula (2) expressing the sulfonic acid anhydride and the R³ and R⁴ in the above general structural formula (3) expressing the sulfite derivative are each an independent organic residue having a carbon number in the range of 1 to 10. Preferably, R¹, R², R³ and R⁴ are each an alkyl group having a carbon number in the range of 1 to 10 and whose hydrogen atoms may be partially or entirely substituted with fluorine atoms, and specific examples of which include a methyl group, an ethyl group, a propyl group, an isopropyl group, a butyl group, and an isobutyl group. Further, R¹, R², R³ and R⁴ may be each an aromatic group having a carbon number in the range of 6 to 10. It is preferable that R¹, R², R³ and R⁴ each has a carbon number of not less than 2 and not more than 6. More preferably, R⁴ is an alkyl group or a benzyl group having a carbon number in the range of 1 to 6. A sulfonic acid anhydride or a sulfonate derivative in which R¹, R², R³ and R⁴ each has a carbon number larger than 10 is less dissolvable in the non-aqueous electrolyte, so that its effect cannot be easily expressed.

The sulfonic acid anhydride is either a symmetrical anhydride, an asymmetrical anhydride derived from two different acids (also referred to as a mixed anhydride) or acid anhydride ester-acid anhydride including partial ester as an acid residue. Specific examples of which include ethane methane sulfonic acid anhydride, propane sulfonic acid anhydride, butanesulfonic acid anhydride, pentanesulfonic acid anhydride, hexanesulfonic acid anhydride, heptanesulfonic acid anhydride, butane ethane sulfonic acid anhydride, butane hexane sulfonic acid anhydride, and benzene sulfonic acid anhydride. These sulfonic acid anhydrides may be used alone or in combination of two or more. Among them, propanesulfonic acid anhydride, butanesulfonic acid anhydride, butane pentane sulfonic acid anhydride, pentanesulfonic acid anhydride, and hexanesulfonic acid anhydride are particularly preferred.

Examples of sulfonate derivatives include (chain) alkyl sulfonates, such as methyl methanesulfonate, ethyl methanesulfonate, propyl methanesulfonate, isobutyl methanesulfonate, methyl ethanesulfonate, pentanyl methanesulfonate, hexyl methanesulfonate, ethyl ethanesulfonate, propyl ethanesulfonate, isobutyl ethanesulfonate, ethyl propanesulfonate, propyl propanesulfonate, butyl propanesulfonate, methyl butanesulfonate, ethyl butanesulfonate, propyl butanesulfonate, methyl pentanesulfonate, ethyl pentanesulfonate, ethyl hexanesulfonate, methyl hexanesulfonate, propyl hexanesulfonate, methyl benzenesulfonate, ethyl benzenesulfonate, propyl benzenesulfonate, phenyl methanesulfonate, phenyl ethanesulfonate, phenyl propanesulfonate, benzyl methanesulfonate, benzyl ethanesulfonate, and benzyl propanesulfonate; chain aromatic sulfonate, such as methyl benzylsulfonate, ethyl benzylsulfonate and propyl benzylsulfonate; and fluorinated compound of the above-described sulfonates. The sulfonate derivative can be used alone or in combination of two or more. Among them, ethyl propanesulfonate, methyl butanesulfonate, ethyl butanesulfonate, methyl pentanesulfonate and ethyl pentanesulfonate are preferable particularly. It is also possible to use in combination at least one of the sulfonic acid anhydrides and at least one of the sulfonate derivatives.

Preferably the content of the sulfonic acid anhydride in the non-aqueous electrolyte to be used for the battery is not less than 0.2 mass % for example, and more preferably not less than 0.3 mass %. It is also preferable that the content is not more than 2 mass %, and more preferably not more than 1 mass %. Preferably, the content of the sulfonate derivative in the non-aqueous electrolyte to be used for the battery is not less than 0.2 mass % for example, and more preferably not less than 0.3 mass %. It is also preferable that the content is not more than 5 mass %, and more preferably not more than 3 mass %. If the contents of the sulfonic acid anhydride and the sulfonate derivative in the non-aqueous electrolyte are insufficient, the effect to be achieved by use thereof (the effect of improving the safety, the charge/discharge cycle characteristics, and the storage characteristics at high temperature) may be decreased. If the contents are excessive, the film to be formed by the reaction with the positive and negative electrodes may be thickened to raise the resistance, and thus it may be difficult to configure a battery having a high performance.

It is preferable that the non-aqueous electrolyte contains fluoroethers and/or fluorocarbonates. Since fluoroethers and fluorocarbonates have higher oxidation potentials in comparison with an ordinary organic solvent (non-fluoridated solvent) to be used for the non-aqueous electrolyte, it is unlikely to undergo a decomposition reaction within the battery in a charged state. Therefore, in a battery using a non-aqueous electrolyte containing fluoroethers and/or fluorocarbonates, gas generation within the battery and a temperature rise within the battery caused by the decomposition reaction of the solvent of the non-aqueous electrolyte will be inhibited. Further, the fluoroethers and fluorocarbonates have flame retardance superior to that of an non-fluoridated solvent. As a result, a battery using a non-aqueous electrolyte containing fluoroethers and fluorocarbonates as the solvent exhibits a favorable safety.

Specific examples of the fluoroethers include: chain ethers such as dimethoxyethane, methoxyethoxy ethane, diethoxyethane, diethyl ether, ethyl propyl ether, dipropyl ether, diglyme, triglyme, and tetraglyme; cyclic ethers such as dioxane tetrahydrofuran, and 2-methyl tetrahydrofuran; and, either a chain ether or a cyclic ether having a structure where H in at least a part of the C—H bond is substituted with F so as to make a C—F bond. The specific examples include: fluoromethoxy methoxyethane, bis(fluoromethoxy)ethane, fluoromethoxy fluororoethoxyethane, methoxyfluoro ethoxyethane, fluoroethoxy ethoxyethane, bis(fluoroethoxy)ethane, fluoroethyl ethylether, bis(fluoroethyl)ether, fluoroethyl propylether, ethyl fluoropropylether, fluoromethyl diglyme, fluoro triglyme, fluoro tetraglyme, 2-fluoro-1,4-dioxane, 2-fluoro-tetrahydrofuran, and 2-methyl-4-fluorotetrahydrofuran.

Specific examples of the fluorocarbonates include: chain carbonates such as dimethyl carbonate, diethyl carbonate, and methylethyl carbonate; cyclic carbonates such as ethylene carbonate, propylene carbonate, butylene carbonate and vinyl ethylene carbonate; and, either a chain carbonate or a cyclic carbonate having a structure where H in at least a part of the C—H bond is substituted with F so as to make a C—F bond. The specific examples include: fluoromethyl methyl carbonate, bis(fluoromethyl)carbonate, fluoromethyl ethyl carbonate, fluoropropyl ethyl carbonate, methyl fluoroethyl carbonate, fluoromethyl fluoroethyl carbonate, fluoroethyl ethyl carbonate, bis(fluoroethyl)carbonate, 4-fluoro-1,3-dioxolane-2-on, 4,5-difluoro-1,3-dioxolane-2-on, and trifluoropropylene carbonate.

For the non-aqueous electrolyte, one of the above-listed fluoroethers and fluorocarbonates may be used alone or in combination of two or more.

In a case of containing the fluoroethers in the non-aqueous electrolyte, it is preferable that the content of the fluoroethers in the whole solvent of the non-aqueous electrolyte is in the range of 0.1 to 20 volume %. In a case of containing the fluorocarbonates in the non-aqueous electrolyte, it is preferable that the content of the fluorocarbonates in the whole solvent of the non-aqueous electrolyte is in the range of 0.1 to 20 volume %.

Further, borates and/or phosphates may be contained in the non-aqueous electrolyte. The borates and the phosphates form a film on the positive electrode surface of the battery, the film being capable of inhibiting unnecessary reactions between the positive electrode and the non-aqueous electrolyte.

Specific examples of the borates include: boric acid monoesters such as methyl borate, ethyl borate, propyl borate, butyl borate, and cyanoethyl borate; boric acid diesters such as dimethyl borate, diethyl borate, dipropyl borate, dibutyl borate, methlcyanoethyl borate, and methyl propyl borate; boric acid triesters such as trimethyl borate, triethyl borate, dimethylethyl borate, methyl(dicyanoethyl)borate, and tricyanoethyl borate; and cyclic boric acid anhydrides such as trimethyl boroxin, triethyl boroxin, tripropyl boroxin, and methyl diethyl boroxin. Specific examples of phosphates include: phosphoric acid monoesters such as methyl phosphate, ethyl phosphate, propyl phosphate, butyl phosphate, hexyl phosphate, and octyl phosphate; phosphoric acid diesters such as dimethyl phosphate, diethyl phosphate, dipropyl phosphate, dibutyl phosphate, dihexyl phosphate, and dioctyl phosphate; and phosphoric acid triesters such as trimethyl phosphate, triethyl phosphate, tripropyl phosphate, tributyl phosphate, trihexyl phosphate, and trioctyl phosphate.

It is preferable that the content of the borate in the non-aqueous electrolyte to be used for the battery is 0.01 to 5 mass %. And it is preferable that the content of the phosphate in the non-aqueous electrolyte to be used for the battery is 0.01 to 5 mass %.

Also it is possible to suitably add to the non-aqueous electrolyte an additive such as vinylene carbonates, 1,3-propane sultone, diphenyl disulfide, cyclohexylbenzene, biphenyl, fluorobenzene or t-butylbenzene in order to further improve the characteristics such as the safety and charge/discharge cycle characteristics of the battery

<Negative Electrode>

The negative electrode applicable to the non-aqueous secondary battery of the present invention is prepared by providing, on at least one surface of a current collector, a negative electrode material mixture layer containing a negative electrode active material, a binder and the like.

Examples of applicable negative electrode active material include: carbon materials capable of occluding or desorbing lithium ions; a material composed of an element (for example, Si, Sn, Ge, Bi, Sb, and In) that is capable of being alloyed with lithium or a material (for example, alloy or oxide) including a material that is capable of being alloyed with lithium; lithium or lithium alloy (for example, lithium/aluminum); and Li₄Ti₅O₁₂ as a high-output negative electrode material. Examples of the carbon material include graphite (natural graphite; artificial graphite prepared by graphitizing an easily-graphitizable carbon such as pyrolytic carbons, MCMB and carbon fiber at temperature of 2800° C. or higher), pyrolytic carbons, cokes, glassy carbons, fired substance of an organic polymer compound, mesocarbon microbeads, carbon fiber, and activated carbon.

Among them, in light of the capability of configuring a battery of a higher capacity, graphite, or a material composed of an element that is capable of being alloyed with lithium, or a material including such an element, are preferred.

For the material including an element that is capable of being alloyed with lithium, a material including silicon (Si) and oxygen (O) as the constituent elements, which is expressed by a general compositional formula (2) below, are preferred in particular.

SiOₓ (2)

In the general compositional formula (2) above, 0.5≦x≦1.5. Hereinafter, the material expressed by the general compositional formula (2) is denoted as “SiOₓ”.

SiO may include an Si microcrystalline or amorphous phase. In this case, the atomic ratio between Si and O is a ratio including Si in the Si microcrystalline or amorphous phase. That is, the materials represented by SiOₓ include those having such a structure that Si (e.g., microcrystalline Si) is dispersed in an amorphous SiO₂ matrix. In this case, the atomic ratio x, including the amorphous SiO₂ and Si dispersed therein, may satisfy 0.5≦x≦1.5. For example, in the case of a material having a structure in which Si is dispersed in an amorphous SiO₂ matrix and the molar ratio between SiO₂ and Si is 1:1, x is equal to 1 (x=1). Thus, this material can be represented by the structural formula SiO. When a material having such a structure is analyzed by, for example, X-ray diffractometry, a peak resulting from the presence of Si (microcrystalline Si) may not be observed. However, when the material is observed under a transmission electron microscope, the presence of impalpable Si can be recognized.

Since SiOₓ is poor in conductivity, the surface of SiOₓ may be coated with carbon, for example. As a result, a conductive network can be formed more favorably in the negative electrode.

For example, carbon such as low crystalline carbon, carbon nanotubes or vapor-grown carbon fibers can be used to coat the surface of SiOₓ.

When the surface of SiO is coated with carbon by heating hydrocarbon gas in a vapor phase and depositing on the surface of the SiOₓ particles carbon resulting from the thermal decomposition of the hydrocarbon gas [chemical vapor deposition (CVD)], the hydrocarbon gas can be distributed throughout the SiOₓ particles. Thus, a thin and uniform coating containing conductive carbon (i.e., carbon coating layer) can be formed on the surface of the particles and in holes in the surface. Thus, conductivity can be imparted to the SiOₓ particles uniformly using a small amount of carbon.

Although toluene, benzene, xylene, mesitylene or the like can be used as the liquid source of the hydrocarbon gas used in CVD, toluene is particularly preferable because it is easy to handle. The hydrocarbon gas can be obtained by evaporating (e.g., bubbling with nitrogen gas) any of these liquid sources. Further, it is also possible to use methane gas, ethylene gas, acetylene gas, and the like.

The treatment temperature used in CVD is preferably, for example, 600 to 1200° C. Further, SiOₓ to be subjected to CVD is preferably of granules (composite particles) granulated by a known method.

When coating the surface of SiOₓ with carbon, the amount of carbon is preferably 5 mass parts or more and more preferably 10 mass parts or more, and preferably 95 mass parts or less and more preferably 90 mass parts or less with respect to 100 mass parts of SiOₓ.

In a case of using a negative electrode including a high capacity negative electrode material such as a material composed of an element (Si, Sn, Ge, Bi, Sb, In and the like) that is capable of being alloyed with lithium and a material including these elements (alloys, oxides and the like), lithium or lithium alloy (lithium/aluminum and the like), for example, in a case of using a negative electrode including SiOₓ, and in a case of using a negative electrode including a high-output negative electrode material such as Li₄Ti₅O₁₂, in many cases the compound C is used preferably to the compound B as the additive to the non-aqueous electrolyte. Though the details of the mechanism has not been clarified, a film formed on a negative electrode by using a non-aqueous electrolyte including the compound B with respect to the negative electrode using the above-described high capacity negative electrode material or the high-output negative electrode material may be inferior in the stability when compared to a film formed on a negative electrode by using the non-aqueous electrolyte including the compound B with respect to the negative electrode consisting of only the graphite-based negative electrode material. Therefore, with respect to the negative electrode using either the high-capacity negative electrode material or the high-output negative electrode material, a combination of the compound A and the compound C is preferred as the combination of additives to the non-aqueous electrolyte.

In a battery where the lithium-containing composite oxide expressed by the general compositional formula (1) is used for the positive electrode active material and SiOₓ is used for the negative electrode active material, the metal that has been eluted from the lithium-containing composite oxide is precipitated selectively on the SiOₓ surface of the negative electrode so as to degrade the negative electrode, and thus deterioration of the charge/discharge cycle characteristics is serious. However, in the battery of the present invention, because of the action of the compound B and the compound C in the non-aqueous electrolyte, precipitation of the metal eluted from the lithium-containing composite oxide at the negative electrode can be inhibited. Further, as deoxidation of the precipitated metal is suppressed, degradation of the negative electrode active material can be inhibited. As a result, even when SiOₓ is used for the negative electrode active material, deterioration of the charge/discharge cycle characteristics caused by the eluted metal can be suppressed effectively.

As SiOₓ undergoes a significant volume change associated with charging/discharging of the battery, in a battery using a negative electrode having a negative electrode material mixture layer including SiOₓ alone as the negative electrode active material, the expansion and contraction of the negative electrode occurring due to the charge and discharge often causes degradation, and it may decrease the effect of improving the charge/discharge cycle characteristics by the use of the above-described non-aqueous electrolyte. For avoiding the problem, it is preferable to use SiOₓ and graphite in combination as the negative electrode active materials. This makes it possible to achieve an increased capacity resulting from the use of SiOₓ, while suppressing expansion/contraction of the negative electrode associated with charging/discharging of the battery, and to maintain the charge/discharge cycle characteristics at a higher level.

When using SiOₓ and graphite in combination as the negative electrode active materials, SiOₓ preferably makes up 0.5 mass % or more of the total amount of the negative electrode active materials from the viewpoint of favorably securing the capacity increasing effect resulting from the use of SiOₓ. Further, from the viewpoint of inhibiting the expansion/contraction of the negative electrode caused by SiOₓ, SiOₓ preferably makes up 10 mass % or less of the total amount of the negative electrode active materials.

In a case of using SiOₓ as the negative electrode active material, it is preferable that the non-aqueous electrolyte contains the fluoroethers and/or the fluorocarbonates. By using the non-aqueous electrolytes, a favorable film including fluorine is formed on the SiOₓ surface of the negative electrode and thus the charge/discharge cycle characteristics of the battery are improved.

Examples of the binder for the negative electrode material mixture layer include: fluororesins such as PVDF, PTFE, and PHFP; synthetic rubber or natural rubber such as styrene-butadiene rubber (SBR), and nitrile rubber (NBR); celluloses such as carboxymethyl-cellulose (CMC), methyl cellulose (MC), and hydroxyethyl cellulose (HEC); acrylic resins such as ethylene-acrylic acid copolymer, ethylene-methacrylic acid copolymer, ethylene-methyl acrylate copolymer, ethylene-methyl methacrylate copolymer, and a crosslinked substance thereof, amides such as polyamide, polyamide imide, and poly-N-vinyl acetamide; polyimide; polyacrylic acid; polyacrylic acid sulfonic acid; and polysaccharides such as xanthan gum and guar gum.

Further, any of the conductive assistants described above as the examples of the conductive assistant applicable to the positive electrode material mixture layer can be used as the conductive assistant for the negative electrode material mixture layer.

The material of the current collector of the negative electrode is not particularly limited as long as an electron conductor that is chemically stable in the configured battery is used. For example, in addition to copper or copper alloys, stainless steel, nickel, titanium, carbon, conductive resins, and composite materials having a carbon layer or titanium layer on the surface of copper, copper alloy or stainless steel can be used. Among these materials, copper and copper alloys are particularly preferable because they are not alloyed with lithium and are highly electron conductive. For the current collector of the negative electrode, for example, a foil, a film, a sheet, a net, a punched sheet, a lath, a porous sheet, a foam or a molded article of fiber bundle made of any of the materials described above can be used. Further, the current collector can be subjected to a surface treatment to roughen the surface. The thickness of the current collector is not particularly limited but is normally 1 to 500 μm.

For example, the negative electrode can be produced through the steps of dispersing a negative electrode material mixture containing a negative electrode active material, a binder, and, as needed, a conductive assistant in a solvent to prepare a negative electrode material mixture-containing composition in the form of a paste or slurry (the binder may be dissolved in the solvent), applying the negative electrode material mixture-containing composition to one or both sides of a current collector, drying the applied composition to form a negative electrode material mixture layer, and, as needed, subjecting to a press process so as to adjust the thickness and density of the negative electrode material mixture layer. The method for producing the negative electrode is not limited to the method as described above, and other methods may be used to produce the negative electrode. The thickness of the negative electrode mixture layer is preferably 10 to 300 μm per one side of the current collector. And the density of the negative electrode material mixture layer measured by the same method for measuring the density of the positive electrode material mixture layer is preferably 1.0 to 2.2 g/cm³ for example.

<Separator>

The separator for the non-aqueous secondary battery of the present invention preferably has such a property that its pores close at 80° C. or higher (more preferably 100° C. or higher) and 180° C. or lower (more preferably 150° C. or lower) (i.e., a shutdown function). The separator can be one used in ordinary non-aqueous secondary batteries, for example, a microporous film made of polyolefin such as polyethylene (PE) or polypropylene (PP). A microporous film serving as the separator may be a film composed only of PE or PP or a laminate of a PE microporous film and a PP microporous film.

For the separator of the battery of the present invention, a laminated separator formed of a first porous layer [hereinafter referred to as porous layer (I)] primarily containing a thermoplastic resin [a thermoplastic resin preferably having a melting point of not lower than 80° C. (more preferably not lower than 100° C.) and not higher than 180° C. (more preferably not higher than 150° C.)] and a second porous layer [hereinafter referred to as porous layer (II)] primarily containing inorganic fine particles having a heat resistant temperature of 200° C. or higher can be used. The term “melting point” as used herein refers to the melting temperature measured using a differential scanning calorimeter (DSC) in accordance with the Japanese Industrial Standard (JIS) K 7121, and the phrase “heat resistant temperature of 200° C. or higher” means that deformation such as softening is not observed at a temperature of at least 200° C.

The porous layer (I) of the laminated separator is mainly to secure a shutdown function, and when the non-aqueous secondary battery reaches the melting point, or a higher temperature, of the resin that serves as the primary component of the porous layer (I), the resin of the porous layer (I) melts and blocks the pores of the separator, and causes shutdown that suppresses progress of an electrochemical reaction.

An example of the thermoplastic resin serving as the primary component of the porous layer (I) may be polyolefins such as PE, PP and ethylene-propylene copolymer, and examples of the configuration thereof include substrates such as a microporous membrane for use in the above-described non-aqueous secondary battery and a nonwoven fabric, to which a dispersion including particles of a thermoplastic resin such as polyolefin is applied, and then dried. Here, relative to the entire components of the porous layer (I), the volume of the thermoplastic resin serving as a primary component is preferably 50 volume % or greater and more preferably 70 volume % or greater. In a case where the porous layer (I) is formed of the aforementioned polyolefin microporous membrane for example, the volume of the thermoplastic resin is 100 volume %.

The porous layer (II) of the laminated separator has a function to prevent a short circuit caused by direct contact between the positive electrode and the negative electrode also when the internal temperature of the non-aqueous secondary battery is increased, and this function is secured by inorganic fine particles having a heat resistant temperature of 200° C. or higher. That is, in the case where the battery reaches high temperatures, even when the porous layer (I) shrinks, a short circuit caused by a direct contact between the positive and negative electrodes, which can occur in the case where the separator thermally shrinks, can be prevented by the porous layer (II), which is unlikely to shrink. Also, because this heat resistant porous layer (II) serves as the backbone of the separator, the thermal shrinkage of the porous layer (I), i.e., the thermal shrinkage itself of the separator as a whole, can be inhibited.

It is sufficient that the inorganic fine particles of the porous layer (II) have a heat resistant temperature of 200° C. or higher, stable against the non-aqueous electrolyte solution contained in the battery, and electrochemically stable so as not to undergo redox in the operational voltage range of the battery, but alumina, silica, and boehmite are preferred. Alumina, silica, and boehmite have a high level of oxidation resistance, and it is possible to adjust their particle sizes and shapes so as to have, for example, desired numerical values, thus making it easy to precisely control the porosity of the porous layer (II). For the inorganic fine particles having a heat resistant temperature of 200° C. or higher, the inorganic fine particles presented above as examples may be used alone or as a combination of two or more.

The shape of the inorganic fine particles having a heat resistant temperature of 200° C. or higher of the porous layer (II) is not particularly limited, and those that have various shapes such as a substantially spherical shape (including a perfectly spherical shape), a substantially spheroidal shape (including a spheroidal shape), and a plate shape can be used.

The average particle size of the inorganic fine particles having a heat resistant temperature of 200° C. or higher of the porous layer (II) is preferably 0.3 μm or greater and more preferably 0.5 μm or greater since an excessively small average particle size results in reduced ion permeability. Also, when the inorganic fine particles having a heat resistant temperature of 200° C. or higher are excessively large, electrical characteristics are likely to be degraded, and thus the average particle size thereof is preferably 5 μm or less and more preferably 2 μm or less. The average particle size of the inorganic fine particles as referred to herein is an average particle size D50% measured by, for example, dispersing fine particles in a medium using a laser scattering particle size distribution analyzer (such as “LA-920” available from Horiba Ltd).

The content of the inorganic fine particles having a heat resistant temperature of 200° C. or higher in the porous layer (II) is 50 volume % or greater relative to the total volume of the components of the porous layer (II) since the inorganic fine particles are contained as a primary component of the porous layer (II), preferably 70 volume % or greater, more preferably 80 volume % or greater, and even more preferably 90 volume % or greater. With the inorganic fine particles being contained in the porous layer (II) in a high content as described above, the thermal shrinkage of the separator as a whole can be favorably inhibited even when the non-aqueous secondary battery reaches high temperatures, and thus generation of a short circuit by direct contact between the positive electrode and the negative electrode can be inhibited more favorably.

As will be described later, it is preferable that the porous layer (II) contains an organic binder, and therefore the content of the inorganic fine particles having a heat resistant temperature of 200° C. or higher in the porous layer (II) is preferably 99.5 volume % or less in the total volume of the components of the porous layer (II).

The porous layer (II) preferably contains an organic binder in order to bind the inorganic fine particles having a heat resistant temperature of 200° C. or more, or to integrate the porous layer (II) and the porous layer (I). Examples of the organic binder include an ethylene-vinyl acetate copolymer (EVA containing a vinyl acetate-derived structural unit in an amount of 20 mol % or more and 35 mol % or less), an ethylene-acrylic acid copolymer such as an ethylene-ethyl acrylate copolymer, fluorine-based rubber, SBR, CMC, hydroxyethyl cellulose (HEC), polyvinyl alcohol (PVA), polyvinyl butyral (PVB), polyvinyl pyrrolidone (PVP), crosslinked acrylic resin, polyurethane, and epoxy resin. In particular, a heat resistant binder having a heat resistant temperature of 200° C. or higher is used preferably. The organic binders listed above may be used alone or in a combination of two or more.

Among the organic binders listed above, it is preferable to use highly flexible binders such as EVA, an ethylene-acrylic acid copolymer, a fluorine-based rubber and SBR. Specific examples of such highly flexible organic binders include “Evaflex series” (EVA) available from DuPont-Mitsui Polychemicals Co., Ltd., EVA available from Nippon Unicar Company Limited, “Eva flex-EEA series” (ethylene-acrylic acid copolymer) available from DuPont-Mitsui Polychemicals Co., Ltd., EEA available from Nippon Unicar Company Limited, “DAI-EL Latex series” (fluorine rubber) available from Daikin Industries, Ltd., “TRD-2001” (SBR) available from JSR, and “BM-400B” (SBR) available from Zeon Corporation, Japan.

In the case of using the organic binder in the porous layer (II), it can be used in an emulsion form in which it is dissolved or dispersed in a solvent for a porous layer (II) forming composition, which will be described later.

The laminated type separator can be produced by, for example, applying a porous layer (II) forming composition (for example, a slurry) containing inorganic fine particles having a heat resistant temperature of 200° C. or higher or the like on the surface of a microporous film for forming a porous layer (I) and drying it at a predetermined temperature to form a porous layer (II).

The porous layer (II) forming composition contains inorganic fine particles having a heat resistant temperature of 200° C. or more, and optionally an organic binder and the like, and can be obtained by dispersing these in a solvent (including a dispersing medium, the same applies hereinafter). The organic binder may be dissolved in the solvent. The solvent used in the porous layer (II) forming composition can be any solvent as long as the inorganic fine particles or the like can be uniformly dispersed, and the organic binder can be uniformly dissolved or dispersed, and commonly used organic solvents are preferably used. The examples include aromatic hydrocarbons such as toluene, furans such as tetrahydrofuran, and ketones such as methyl ethyl ketone and methyl isobutyl ketone. For the purpose of controlling the interfacial tension, an alcohol (ethylene glycol, propylene glycol or the like), a propylene oxide-based glycol ether such as monomethyl acetate or the like may be added to these solvents as appropriate. In the case where the organic binder is water-soluble or is used as an emulsion, the solvent may be water. In this case as well, an alcohol (methyl alcohol, ethyl alcohol, isopropyl alcohol, ethylene glycol or the like) may be added as appropriate so as to control the interfacial tension.

In the porous layer (II) forming composition, the solid content including inorganic fine particles having a heat resistant temperature of 200° C. or more, the organic binder and the like is preferably, for example, 10 mass % or more and 80 mass % or less.

In the laminated type separator, the porous layer (I) and the porous layer (II) are not necessarily single layers, and respectively a plurality of layers may be included in the separator. For example, it is possible to employ a configuration in which the porous layer (I) is placed on both sides of the porous layer (II) or a configuration in which the porous layer (II) is placed on both sides of the porous layer (I). However, increasing the number of layers to increase the separator thickness may cause an increase in the internal resistance of the battery and a reduction in the energy density, and thus a too large number of layers is not preferable. The total number of the porous layers (I) and the porous layers (II) in the laminated type separator is preferably 5 or less.

The separator (a separator made of a polyolefin microporous film, or the above-described laminated type separator) included in the battery of the present invention preferably has a thickness of, for example, 10 μm or more and 30 μm or less.

In the laminated type separator, the porous layer (II) preferably has a thickness [the total thickness if the separator has a plurality of porous layers (II)] of 3 μm or more from the viewpoint of effectively exhibiting the above-described actions of the porous layer (II). However, if the porous layer (II) is too thick, there is a possibility that the energy density of the battery might be reduced for example, and thus the thickness of the porous layer (II) is preferably 8 μm or less.

Furthermore, in the laminated type separator, the porous layer (I) preferably has a thickness [the total thickness if the separator has a plurality of porous layers (I), the same applies hereinafter] of 6 μm or more, and more preferably 10 μm or more from the viewpoint of effectively exhibiting the above-described actions (the shutdown action in particular) obtained by using the porous layer (I). However, if the porous layer (I) is too thick, there is a possibility that the energy density of the battery might be reduced, and that the action that suppresses the overall thermal shrinkage of the separator might be small due to increasing force of the porous layer (I) trying to thermally shrink. Accordingly, the porous layer (I) preferably has a thickness of 25 μm or less, more preferably 20 μm or less, and even more preferably 14 μm or less.

The overall porosity of the separator is preferably 30% or more in the dry state in order to secure the amount of non-aqueous electrolyte solution retained and to obtain better ion permeability. On the other hand, from the viewpoint of securing the separator strength and preventing internal short-circuiting, the porosity of the separator is preferably 70% or less in the dry state. The porosity P(%) of the separator can be calculated by determining the total sum of individual components i using the Equation below from the thickness of the separator, the mass per area, and the density of component.

P={1−(m/t)/(Σaᵢρᵢ)}×100

where aᵢ is the proportion of component iwhen the total mass is taken as 1, ρ₁ is the density (g/cm³) of component i, m is the mass per unit area (g/cm²) of the separator, and t is the thickness (cm) of the separator.

In the case of the laminated type separator, the porosity P(%) of the porous layer (I) can be determined using Equation above by taking m as the mass per unit area (g/cm²) of the porous layer (I), and t as the thickness (cm) of the porous layer (I) in Equation. The porosity of the porous layer (I) determined by this method is preferably 30% or more and 70% or less.

Furthermore, in the case of the laminated type separator, the porosity P(%) of the porous layer (II) can be determined as well using Equation above by taking m as the mass per unit area (g/cm²) of the porous layer (II), and t as the thickness (cm) of the porous layer (II) in Equation. The porosity of the porous layer (II) determined by this method is preferably 20% or more and 60% or less.

The separator preferably has a high mechanical strength, and preferably has, for example, a piercing strength of 3 N or more. In the case where, for example, SiOₓ whose volume changes significantly due to charge and discharge is used as a negative electrode active material, mechanical damage is applied to the separator facing the negative electrode as well due to expansion and contraction of the entire negative electrode as a result of repetition of charge and discharge. If the separator has a piercing strength of 3 N or more, a favorable mechanical strength can be secured, and the mechanical damage to the separator can be mitigated.

An example of the separator having a piercing strength of 3 N or more can be the above-described laminated type separator, and in particular, a separator in which a porous layer (II) primarily containing inorganic fine particles having a heat resistant temperature of 200° C. or higher is laminated on a porous layer (I) primarily containing a thermoplastic resin is preferable. This is presumably because since the mechanical strength of the inorganic fine particles is high, the mechanical strength of the porous layer (I) is reinforced, as a result of which the overall mechanical strength of the separator can be increased.

The piercing strength can be measured by the following method. The separator is fixed onto a plate having a 2-inch diameter hole without creating wrinkles and sags, and a hemispherical metallic pin with a tip diameter of 1.0 mm is penetrated through the measurement sample at a speed of 120 mm/min, and the force required to form a hole in the separator is measured five times. Then, three measured values out of the five measured values excluding the highest and lowest values are averaged and defined as the piercing strength of the separator.

<Electrode Assembly>

The above-described positive electrode, the above-described negative electrode and the above-described separator can be used in the form of a laminate electrode assembly in which the positive electrode and the negative electrode are laminated with the separator interposed therebetween or a wound electrode assembly obtained by winding the laminate electrode assembly in a spiral fashion, in the battery of the present invention.

<Non-Aqueous Secondary Battery>

The non-aqueous secondary battery of the present invention is configured by laminating the positive electrode and the negative electrode described above through the separator to produce a laminated electrode assembly or further winding the laminated electrode assembly in a spiral fashion to produce a wound electrode assembly, placing such an electrode assembly and the non-aqueous electrolyte of the present invention in an outer case in the usual manner, and sealing the outer case. As with conventionally-known batteries, the form of the non-aqueous secondary battery of the present invention may be cylindrical using a cylindrical (e.g., circular cylindrical or rectangular cylindrical) outer case or flat using a flat (circularly or rectangularly flat in plan view) outer case or the non-aqueous secondary battery may be of a soft package type using a metal-evaporated laminated film as an outer case member. As the outer case, those made of steel and aluminum can be used.

The non-aqueous secondary battery of the present invention can be used in applications including power sources for various electronic devices such as portable electronic devices including portable phones, notebook personal computers, and the like, and can be also used in applications such as power sources for electric tools, automobiles, bicycles, and batteries for electric power storages.

### EXAMPLES

Hereinafter, the present invention will be described in detail by way of examples. It should be noted, however, that the examples given below are not intended to limit the scope of the present invention.

### Example 1

### Synthesis of Lithium-Containing Composite Oxide

A coprecipitated compound (spherical coprecipitated compound) containing Ni, Co and Mn was synthesized by placing, in a reaction vessel, ammonia water having a pH adjusted to approximately 12 by addition of sodium hydroxide, and then, while strongly stirring, adding dropwise a mixed aqueous solution containing nickel sulfate, cobalt sulfate and manganese sulfate at a concentration of 2.4 mol/dm³, 0.8 mol/dm³ and 0.8 mol/dm³ respectively, and ammonia water having a concentration of 25 mass % at a rate of 23 cm³/min and 6.6 cm³/min respectively, using a metering pump. At this time, the temperature of the reaction solution was held at 50° C., an aqueous solution of sodium hydroxide having a concentration of 6.4 mol/dm³ was also added dropwise such that the pH of the reaction solution was maintained at around 12, and a nitrogen gas was bubbled at a flow rate of 1 dm³/min.

The coprecipitated compound was washed with water, filtrated and dried to obtain a hydroxide containing Ni, Co and Mn at a molar ratio of 6:2:2. The obtained hydroxide in an amount of 0.194 mol and 0.206 mol of LiOH.H₂O were dispersed in ethanol to form slurry, and the slurry was mixed for 40 minutes using a planetary ball mill and dried at room temperature to obtain a mixture. Subsequently, the mixture was placed in an alumina crucible, heated to 600° C. in a dry air flow of 2 dm³/min, held at that temperature for two hours for preheating, and fired for 12 hours by increasing the temperature to 900° C. A lithium-containing composite oxide was thereby synthesized. The obtained lithium-containing composite oxide was pulverized into powder using a mortar, and stored in a desiccator.

The lithium-containing composite oxide was analyzed for its composition by an atomic absorption spectrometer, and was found to have a composition represented by Li_{1.06}Ni_{0.6}Cu_{0.2}Mn_{0.2}O₂.

<Production of Positive Electrode>

A positive electrode material mixture-containing paste was prepared by kneading 100 mass parts of the lithium-containing composite oxide (positive electrode active material), 20 mass parts of an N-methyl-2-pyrrolidone (NMP) solution containing PVDF as a binder at a concentration of 10 mass %, 1.0 mass parts of artificial graphite and 1.0 mass parts of Ketjen black, both of which were conductive assistants, with the use of a biaxial kneader and then adding NMP further for viscosity adjustment.

The positive electrode material mixture-containing paste was applied to both sides of a 15 μm thick aluminum foil (positive electrode current collector), and then vacuum-dried at 120° C. for 12 hours to form positive electrode material mixture layers on both sides of the aluminum foil. After that, pressing was performed to adjust the thickness and density of the positive electrode material mixture layers, a lead connector made of nickel was welded to an exposed portion of the aluminum foil, and a strip-shaped positive electrode having a length of 375 mm and a width of 43 mm was produced. The positive electrode material mixture layer of the obtained positive electrode had a thickness of 55 μm per side.

<Production of Negative Electrode>

A negative electrode material mixture-containing paste was prepared by adding water to 100 mass parts of natural graphite as a negative electrode active material, 1.5 mass parts of styrene butadiene rubber as a binder and 1.5 mass parts of carboxymethyl cellulose as a thickener and mixing them. The prepared negative electrode material mixture-containing paste was applied to both sides of a 8 μm thick copper foil, and then vacuum-dried at 120° C. for 12 hours to form negative electrode material mixture layers on both sides of the copper foil. After that, pressing was performed to adjust the thickness and density of the negative electrode material mixture layers, a lead connector made of nickel was welded to an exposed portion of the copper foil, and a strip-shaped negative electrode having a length of 380 mm and a width of 44 mm was produced.

<Preparation of Non-Aqueous Electrolyte>

(Step 1)

First, LiPF₆ was dissolved at a concentration of 1 mol/L in a mixed solvent of EC, MEC and DEC at a volume ratio of 1:1:3, in which subsequently vinylene carbonate to be 1 mass % was mixed.

(Step 2)

Next, 1,3-bis(propenoxymethyl)cyclopentane as the compound A, 1,7-bis(butenoic acid)-1,7-diaza-12-crown-4-ether as the compound B (including 1,7-diaza-12-crown-4-ether as the skeleton and in which two nitrogen atoms had butenoic acid residue), and 1,2,4-triazole as the compound C were added to the solution prepared in the above (Step 1) so that the compound A, the compound B and the compound C would be 0.2 mass %, 0.2 mass % and 0.1 mass % respectively. The solution and the compounds were mixed to be homogenized, thereby a non-aqueous electrolyte was prepared.

<Assembling of Battery>

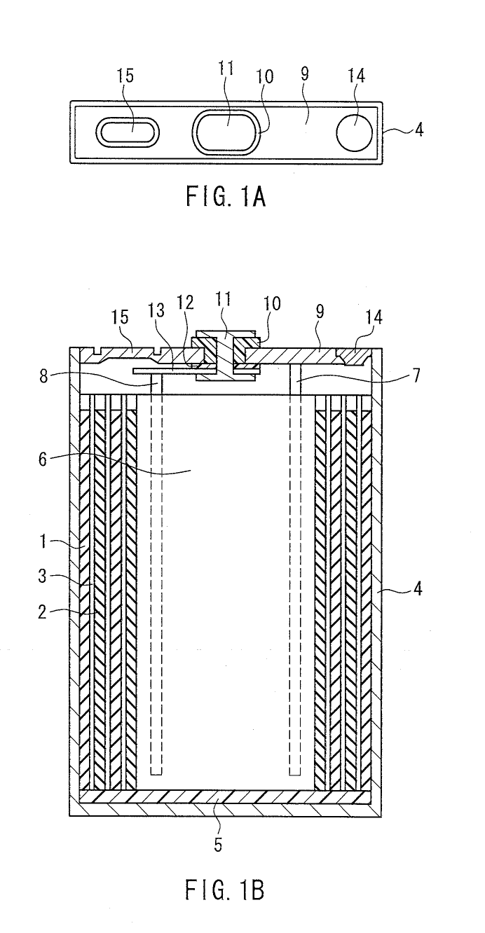

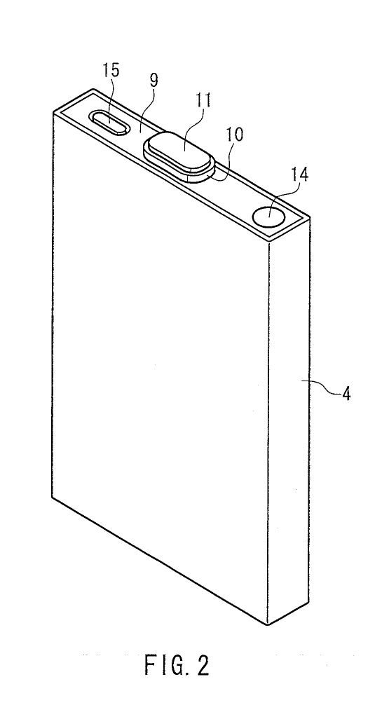

The strip-shaped positive electrode was stacked on top of the strip-shaped negative electrode through a 16 μm-thick microporous polyethylene separator (porosity: 41%), and they were wound in a spiral fashion. Subsequently, they were pressed into a flat shape, thus obtaining a flat wound electrode assembly. The wound electrode assembly was fixed with a polypropylene insulating tape. Next, the wound electrode assembly was inserted in a rectangular battery case made of aluminum alloy and having outer dimensions of 4.0 mm thickness×34 mm width×50 mm height, a lead connector was welded to the battery case, and an aluminum alloy cover plate was welded to an opening end of the battery case. Thereafter, the non-aqueous electrolyte was injected through an inlet formed at the cover and was allowed to stand for 1 hour. Then, the inlet was sealed, and a non-aqueous secondary battery having the structure as shown in FIGS. 1A and 1B and the appearance as shown in FIG. 2 was obtained. The design electric capacity of the non-aqueous secondary battery was about 1000 mAh.

The battery shown in FIGS. 1A, 1B and 2 will be described. FIG. 1A is a plan view and FIG. 1B is a cross-sectional view of FIG. 1A. As shown in FIG. 1B, a positive electrode 1 and a negative electrode 2 are spirally wound via a separator 3, and then pressed into a flat shape to form a flat wound electrode assembly 6, and the electrode assembly 6 is housed in a rectangular (rectangular-cylindrical) battery case 4 together with a non-aqueous electrolyte. In order to simplify the illustration of FIG. 1B, metal foils serving as current collectors used to produce the positive electrode 1 and the negative electrode 2 and the non-aqueous electrolyte are not illustrated.

The battery case 4 is a battery outer case made of an aluminum alloy, and the battery case 4 also serves as a positive electrode terminal. An insulator 5 made of a PE sheet is placed on the bottom of the battery case 4, and a positive electrode lead connector 7 and a negative electrode lead connector 8 connected to the ends of the positive electrode 1 and the negative electrode 2 respectively, are drawn from the wound electrode assembly 6 including the positive electrode 1, the negative electrode 2 and the separator 3. A stainless steel terminal 11 is attached to a sealing cover plate 9 made of an aluminum alloy for sealing the opening of the battery case 4 with a polypropylene insulation packing 10 interposed therebetween, and a stainless steel lead plate 13 is attached to the terminal 11 via an insulator 12 interposed therebetween.

Then, the cover plate 9 is inserted into the opening of the battery case 4, the joint portions of the cover plate 9 and the battery case 4 are welded to seal the opening of the battery case 4, and thereby the interior of the battery is sealed. In the battery shown in FIGS. 1A and 1B, the cover plate 9 is provided with a non-aqueous electrolyte inlet 14, and the inlet 14 is sealed by welding such as laser welding, with a sealing member inserted into the inlet 14, and thereby the seal of the battery is secured. Accordingly, in the battery shown in FIGS. 1A, 1B and 2, the inlet 14 actually includes the non-aqueous electrolyte inlet and the sealing member, but in order to simplify the illustration, they are indicated as the inlet 14. The cover plate 9 is also provided with a rupture vent 15 serving as a mechanism that discharges internal gas to the outside in the event of overheating of the battery.

In the battery of Example 1, the positive electrode lead connector 7 is welded directly to the cover plate 9, whereby the battery case 4 and the cover plate 9 function as a positive electrode terminal. Likewise, the negative electrode lead connector 8 is welded to the lead plate 13, and the negative electrode lead connector 8 and the terminal 11 are electrically connected via the lead plate 13, whereby the terminal 11 functions as a negative electrode terminal. However, the polarity may be reversed depending on the material of the battery case 4 for example.

In FIG. 1B, the innermost portion of the electrode assembly 6 is not shown in cross section. And, FIG. 2 shows the battery in order to indicate that the battery is a prismatic battery.

### Example 2

A lithium-containing composite oxide was synthesized in the same manner as in Example 1, except that a hydroxide containing Ni, Co, Mn and Mg at a molar ratio of 90:5:2.5:2.5 was synthesized by adjusting the concentrations of the raw material compounds of the mixed aqueous solution used to synthesize the coprecipitated compound and the synthesized hydroxide was used, and the molar ratio of this hydroxide to LiOH.H₂O was adjusted. The composition of the obtained lithium-containing composite oxide was examined similarly to Example 1 and the result was Li_{1.03}Ni_{0.9}Co_{0.05}Mn_{0.025}Mg_{0.025}O₂. And the positive electrode was produced in the same manner as in Example 1, except that this lithium-containing composite oxide was used for the positive electrode active material.

Further a negative electrode was produced in the same manner as in Example 1, except that the negative electrode active material was replaced with a mixture of 50 mass parts of natural graphite and 50 mass parts of artificial graphite.

Further, a non-aqueous electrolyte was prepared in the same manner as in Example 1, except that 1,3-bis(propenoxymethyl)cyclohexane was used for the compound A in an amount of 0.2 mass %, 1,7-bis(2-methyl butenoate)-1,7-diaza-15-crown-5-ether was used for the compound B in an amount of 0.1 mass %, and 3-amino-1,2,4-triazole was used for the compound C in an amount of 0.1 mass %.

Then, a non-aqueous secondary battery was produced in the same manner as in Example 1, except that the above-described positive electrode, the above-described negative electrode and the above-described non-aqueous electrolyte were used.

### Example 3

A hydroxide containing Ni, Co and Mg at a molar ratio of 5:2:3 was synthesized in the same manner as in Example 1, except that the concentrations of the raw material compounds in the aqueous solution of the mixture to be used for synthesizing a coprecipitated compound was adjusted. The obtained hydroxide was washed with water, and then mixed with LiOH.H₂O at the substantially same molar ratio and subjected to a heat treatment for 12 hours at 850° C. in the air (the oxygen concentration was about 20 volume %), thereby synthesizing a lithium-containing composite oxide. Compositions of the obtained lithium-containing composite oxide were examined similarly to Example 1, and the result was Li_{1.00}Ni_{0.5}Cu_{0.2}Mn_{0.3}O₂. And, a positive electrode was produced in the same manner as in Example 1, except that this lithium-containing composite oxide was used for the positive electrode active material.

SiO (a number-average particle size of 5.0 μm) was heated to about 1,000° C. in an ebullated bed reactor, and then the heated particles were brought into contact with 25° C. mixed gas of ethane and nitrogen gas to carry out CVD for 60 minutes at 1,000° C. Carbon produced by the thermal decomposition of the mixed gas (hereinafter also referred to as “CVD carbon”) in this way was deposited on the surfaces of the SiO particles so as to form coating layers, thus obtaining a negative electrode material (carbon-coated SiO).

The composition of the negative electrode was calculated from changes in the mass before and after the formation of the coating layer, and it was found that the ratio of SiO to CVD carbon was 80:20 (mass ratio).

A negative electrode was produced in the same manner as in Example 1, except that the negative electrode active material was replaced with a mixture of 50 mass parts of natural graphite having a number average particle size of 10 μm, 49.5 mass parts of artificial graphite, and 0.5 mass parts of the above-described carbon-coated SiO.

Further, a non-aqueous electrolyte was prepared in the same manner as in Example 1, except that 1,3-bis(propenoxyethyl)cycloheptane was used for the compoundA in an amount of 0.1 mass %, 1,10-bis(2-butanoic acid ethyl)-1,10-diaza-18-crown-6-ether was used for the compound B in an amount of 0.2 mass %, and 4-methyl-1,2,3-triazole was used for the compound C in an amount of 0.1 mass %.

Then, a non-aqueous secondary battery was produced in the same manner as in Example 1, except that the above-described positive electrode, the above-described negative electrode and the above-described non-aqueous electrolyte were used.

### Example 4

A positive electrode was produced in the same manner as in Example 1, except that the positive electrode active material was replaced with a mixture of 95 mass parts of the lithium-containing composite oxide which is identical to what was synthesized in Example 2 and 5 mass parts of Li_{1.02}Mn_{1.976}Al_{0.01}Mg_{0.01}Ti_{0.004}O₄.

Further a negative electrode was produced in the same manner as in Example 1, except that the negative electrode active material was replaced with a mixture of 50 mass parts of natural graphite and 50 mass parts of mesophase carbon.

Further, a non-aqueous electrolyte was prepared in the same manner as in Example 1, except that 1,3-bis(vinyloxyethyl)cycloheptane was used for the compound A in an amount of 0.1 mass %, 1,10-bis(2-ethyl pentenoate)-2,3,14,15-dibenzo-1,10-diaza-18-crown-6-ether was used for the compound B in an amount of 0.15 mass %, and 4-amino-1,3-imidazole was used for the compound C in an amount of 0.15 mass %.

Then, a non-aqueous secondary battery was produced in the same manner as in Example 1, except that the above-described positive electrode, the above-described negative electrode and the above-described non-aqueous electrolyte were used.

### Example 5

A positive electrode was produced in the same manner as in Example 1, except that the positive electrode active material was replaced with a mixture of 90 mass parts of a lithium-containing composite oxide identical to what was synthesized in Example 2 and 10 mass parts of Li_{1.00}Co_{0.998}Al_{0.005}Zr_{0.002}O₂.

Further a negative electrode was produced in the same manner as in Example 1, except that the negative electrode active material was replaced with a mixture of 50 mass parts of artificial graphite and 50 mass parts of mesophase carbon.

Further, a non-aqueous electrolyte was prepared in the same manner as in Example 1, except that 1,3-bis(propenoxymethyl)cyclopentane was used for the compoundAin an amount of 0.1 mass %, 1,7-bis(3-fluoro methyl butenoate)-2,3-benzo-1,7-diaza-15-crown-5-ether was used for the compound B in an amount of 0.1 mass %, and 4-amino-1,2-pyrazole was used for the compound C in an amount of 0.1 mass %.

Then, a non-aqueous secondary battery was produced in the same manner as in Example 1, except that the above-described positive electrode, the above-described negative electrode and the above-described non-aqueous electrolyte were used.

### Example 6

A positive electrode was produced in the same manner as in Example 1, except that the positive electrode active material was replaced with a mixture of 90 mass parts of a lithium-containing composite oxide identical to what was synthesized in Example 2 and 10 mass parts of Li_{1.00}Fe_{0.988}Mg_{0.1}Ti_{0.002}PO₄.

Further, a non-aqueous electrolyte was prepared in the same manner as in Example 1 except that 1,3-bis(propenoxymethyl)cyclopentane was used for the compoundAin an amount of 2 mass %, 1,7-bis(3-trifluoromethyl methyl butenoate)-1,7-diaza-15-crown-5-ether was used for the compound B in an amount of 2 mass %, and 2-amino-1,3-pyrimidine was used for the compound C in an amount of 1 mass %.

Then, a non-aqueous secondary battery was produced in the same manner as in Example 1, except that the above-described positive electrode, the above-described non-aqueous electrolyte, and a negative electrode identical to what was produced in Example 2 were used.

### Example 7

A lithium-containing composite oxide was synthesized in the same manner as in Example 3, except that a hydroxide containing Ni, Co and Mn at a molar ratio of 40:30:30 was synthesized by adjusting the concentrations of the raw material compounds of the mixed aqueous solution used to synthesize the coprecipitated compound, and the synthesized hydroxide was washed with water, then 0.198 mol of this hydroxide and 0.202 mol of LiOH.H₂O was mixed. The composition of the obtained lithium-containing composite oxide was examined in the same manner as in Example 1, and the result was: Li_{1.02}Ni_{0.4}Co_{0.3}Mn_{0.302}.

And a positive electrode was produced in the same manner as in Example 1, except that the material was replaced with 90 mass parts of this lithium-containing composite oxide and 10 mass parts of Li_{1.02}Mn_{1.488}Ni_{0.49}Al_{0.01}Mg_{0.01}Ti_{0.002}O₄.

Further a negative electrode was produced in the same manner as in Example 1, except that the negative electrode active material was replaced with a mixture of 50 mass parts of natural graphite and 50 mass parts of mesophase carbon.

Further, a non-aqueous electrolyte was prepared in the same manner as in Example 1, except that 1,3-bis(propenoxymethyl)cyclopentane was used for the compound A in an amount of 1 mass %, 1,7-bis(1-acryloylmethyl)-1,7-diaza-15-crown-5-ether was used for the compound B in an amount of 0.5 mass %, and 2-amino-1,3,6-triazine was used for the compound C in an amount of 0.5 mass %.

Then, a non-aqueous secondary battery was produced in the same manner as in Example 1, except that the above-described positive electrode, the above-described negative electrode and the above-described non-aqueous electrolyte were used.

### Example 8

A hydroxide containing Ni, Co and Mn at a molar ratio of 45:10:45 was synthesized in the same manner as in Example 1, except that the concentration of the raw material compounds in the aqueous solution of the mixture to be used for synthesizing a coprecipitated compound was adjusted. The obtained hydroxide was washed with water, and subjected to a heat treatment for 12 hours at 850° C. in the air (the oxygen concentration was about 20 volume %), thereby synthesizing a lithium-containing composite oxide. Compositions of the obtained lithium-containing composite oxide were examined similarly to Example 1, and the result was Li_{1.00}Ni_{0.45}Co_{0.1}Mn_{0.45}O₂. And, a positive electrode was produced in the same manner as in Example 1, except that this lithium-containing composite oxide was used for the positive electrode active material.

Further, a non-aqueous electrolyte was prepared in the same manner as in Example 1, except that 1,3-bis(propenoxymethyl)cyclopentane was used for the compound A in an amount of 0.02 mass %, 1,4-bis(1-acryloyl ethyl)-1,4-diaza-15-crown-5-ether was used for the compound B in an amount of 0.05 mass %, and 5-amino-indole was used for the compound C in an amount of 0.02 mass %.

Then, a non-aqueous secondary battery was produced in the same manner as in Example 1, except that the above-described positive electrode, the above-described non-aqueous electrolyte, and a negative electrode identical to what was produced in Example 2 were used.

### Example 9

A lithium-containing composite oxide was synthesized in the same manner as in Example 3, except that a hydroxide containing Ni, Co, and Mn at a molar ratio of 34:34:32 was synthesized by adjusting the concentrations of the raw material compounds in the mixed aqueous solution used to synthesize the coprecipitated compound. The composition of the obtained lithium-containing composite oxide was examined in the same manner as in Example 1, and the result was Li_{1.02}Ni_{0.34}Cu_{0.34}Mn_{0.32}O₂. And the positive electrode was produced in the same manner as in Example 1, except that this lithium-containing composite oxide was used for the positive electrode active material.

Further, a non-aqueous electrolyte was prepared in the same manner as in Example 1 except that 1,3-bis(propenoxymethyl)cyclohexane was used for the compoundAin an amount of 0.2 mass %, 1,7-bis(2-methyl butenoate)-1,7-diaza-15-crown-5-ether was used for the compound B in an amount of 0.2 mass %, and the compound C was not used.

Then, a non-aqueous secondary battery was produced in the same manner as in Example 1, except that the above-described positive electrode, the above-described non-aqueous electrolyte, and a negative electrode identical to what was produced in Example 5 were used.

### Example 10

A positive electrode was produced in the same manner as in Example 1, except that the positive electrode active material was replaced with a mixture of 90 mass parts of a lithium-containing composite oxide identical to what was synthesized in Example 7 and 10 mass parts of Li_{1.2}Mn_{0.48}Ni_{0.16}Cu_{0.16}O₂.

Further, a non-aqueous electrolyte was prepared in the same manner as in Example 1, except that 1,3-bis(propenoxymethyl)cyclohexane was used for the compound A in an amount of 1 mass %, 3-amino-1,2,4-triazole was used for the compound C in an amount of 0.5 mass %, and the compound B was not used.

Then, a non-aqueous secondary battery was produced in the same manner as in Example 1, except that the above-described positive electrode, the above-described non-aqueous electrolyte, and a negative electrode identical to what was produced in Example 2 were used.

### Example 11

A positive electrode active material identical to what was used in Example 1, 0.5 mass parts of vapor-grown carbon fiber as a conductive assistant, and 0.5 mass parts of carbon nanotube were mixed by use of a planetary mixer, to which 20 mass parts of NMP solution including PVDF as a binder at a concentration of 10 mass % and further NMP were added for adjusting the viscosity, thereby preparing a positive electrode material mixture containing paste. And a positive electrode was prepared in the same manner as Example 1, except that this positive electrode material mixture containing paste was used.

And, a non-aqueous secondary battery was produced in the same manner as in Example 1 except that the above-described positive electrode and a negative electrode identical to what was produced in Example 2 were used.

### Example 12

A non-aqueous electrolyte was prepared in the same manner as in Example 1, except that propane sultone was added in an amount of 0.1 mass %.

And, a non-aqueous secondary battery was produced in the same manner as in Example 1, except that the above-described non-aqueous electrolyte and a negative electrode identical to what was produced in Example 2 were used.

### Example 13

A negative electrode was produced in the same manner as in Example 1, except that the negative electrode active material was replaced with a mixture of 50 mass parts of natural graphite having a number average particle size of 10 μm, 49.5 mass parts of mesophase carbon and 0.5 mass parts of carbon-coated SiO identical to what was produced in Example 3.

Further, a non-aqueous electrolyte was prepared in the same manner as in Example 1, except that 4-fluoro-1,3-dioxolane-2-on was added in an amount of 0.1 mass %.

And, a non-aqueous secondary battery was produced in the same manner as in Example 1, except that the above-described non-aqueous electrolyte and the above-described negative electrode were used.

### Example 14

A negative electrode was produced in the same manner as in Example 1, except that the negative electrode active material was replaced with a mixture of 50 mass parts of artificial graphite, 49.5 mass parts of mesophase carbon and 0.5 mass parts of carbon-coated SiO identical to what was produced in Example 3.

Further, a non-aqueous electrolyte was prepared in the same manner as in Example 1, except that (n-trifluoropropyl)ethyl ether was added in an amount of 0.1 mass %.

And, a non-aqueous secondary battery was produced in the same manner as in Example 1, except that the above-described non-aqueous electrolyte and the above-described negative electrode were used.

### Example 15

A negative electrode was produced in the same manner as in Example 1, except that the negative electrode active material was replaced with a mixture of 50 mass parts of natural graphite having a number average particle size of 10 μm, 45 mass parts of artificial graphite and 5 mass parts of carbon-coated SiO identical to what was produced in Example 3.

Further, a non-aqueous electrolyte was prepared in the same manner as in Example 1, except that 1,4-bis(propenoxymethyl)cyclohexane was used for the compound A in an amount of 0.2 mass %, 1,7-bis(2-methyl butenoate)-1,7-diaza-15-crown-5-ether was used for the compound B in an amount of 0.2 mass %, the compound C was not used, and 4-fluoro-1,3-dioxolane-2-on was added further in an amount of 1 mass %.

And, a non-aqueous secondary battery was produced in the same manner as in Example 1, except that a positive electrode identical to what was produced in Example 2, the above-described negative electrode, and the above-described non-aqueous electrolyte were used.

### Example 16

A positive electrode was produced in the same manner as in Example 1, except that the positive electrode active material was replaced with Li_{1.02}Ni_{0.82}Cu_{0.15}Al_{0.03}O₂.

Further, a non-aqueous electrolyte was prepared in the same manner as in Example 1, except that 1,4-bis(propenoxymethyl)cyclohexane was used for the compoundAin an amount of 0.2 mass %, 1,7-bis(2-methyl butenoate)-1,7-diaza-15-crown-5-ether was used for the compound B in an amount of 0.2 mass %, the compound C was not used, and trans-4,5-difluoro-1,3-dioxolane-2-on was added further in an amount of 0.5 mass %.

And, a non-aqueous secondary battery was produced in the same manner as in Example 1 except that the above-described positive electrode, a negative electrode identical to what was produced in Example 15, and the above-described non-aqueous electrolyte were used.

### Example 17

A non-aqueous electrolyte was prepared in the same manner as in Example 1, except that 1,4-bis(propenoxymethyl)cyclohexane was used for the compoundAin an amount of 0.2 mass %, 3-amino-1,2,4-triazole was used for the compound C in an amount of 0.2 mass %, the compound B was not used, and 4-fluoro-1,3-dioxolane-2-on was added further in an amount of 1 mass %.

And, a non-aqueous secondary battery was produced in the same manner as in Example 1, except that a positive electrode identical to what was produced in Example 2, a negative electrode identical to what was produced in Example 15, and the above-described non-aqueous electrolyte were used.

### Example 18

A non-aqueous electrolyte was prepared in the same manner as in Example 1 except that 1,4-bis(propenoxymethyl)cyclohexane was used for the compoundAin an amount of 0.2 mass %, 3-amino-1,2,4-triazole was used for the compound C in an amount of 0.2 mass %, the compound B was not used, and fluoroethyl propylether was added further in an amount of 5 mass %.

And, a non-aqueous secondary battery was produced in the same manner as in Example 1 except that a negative electrode identical to what was produced in Example 15 and the above-described non-aqueous electrolyte were used.

### Example 19

A non-aqueous electrolyte was prepared in the same manner as in Example 1 except that 1,4-bis(propenoxymethyl)cyclohexane was used for the compoundAin an amount of 0.2 mass %, 3-amino-1,2,4-triazole was used for the compound C in an amount of 0.2 mass %, the compound B was not used, and fluoropropyl ethyl carbonate was added further in an amount of 0.7 mass %.

And, a non-aqueous secondary battery was produced in the same manner as in Example 1 except that a positive electrode identical to what was produced in Example 2, a negative electrode identical to what was produced in Example 15, and the above-described non-aqueous electrolyte were used.

### Example 20

A non-aqueous electrolyte was prepared in the same manner as in Example 1, except that 1,4-bis(propenoxymethyl)cyclohexane was used for the compound A in an amount of 0.2 mass %, 3-amino-1,2,4-triazole was used for the compound C in an amount of 0.2 mass %, the compound B was not used, and trifluoropropylene carbonate was added further in an amount of 1.0 mass %.

And, a non-aqueous secondary battery was produced in the same manner as in Example 1, except that a positive electrode identical to what was produced in Example 2, a negative electrode identical to what was produced in Example 15, and the above-described non-aqueous electrolyte were used.

### Example 21

A non-aqueous electrolyte was prepared in the same manner as in Example 1 except that 1,4-bis(propenoxymethyl)cyclohexane was used for the compound A in an amount of 0.1 mass %, 3-amino-1,2,4-triazole was used for the compound C in an amount of 0.1 mass %, the compound B was not used, and 4-fluoro-1,3-dioxolane-2-on was added further in an amount of 0.1 mass %.

And, a non-aqueous secondary battery was produced in the same manner as in Example 3, except that the above-described non-aqueous electrolyte was used.

### Example 22

A non-aqueous electrolyte was prepared in the same manner as in Example 1, except that 1,4-bis(propenoxymethyl)cyclohexane was used for the compound A in an amount of 0.2 mass %, 3-amino-1,2,4-triazole was used for the compound C in an amount of 0.2 mass %, the compound B was not used, and 4-fluoro-1,3-dioxolane-2-on was added further in an amount of 0.1 mass %.

And, a non-aqueous secondary battery was produced in the same manner as in Example 13, except that the above-described non-aqueous electrolyte was used.

### Example 23

A negative electrode was produced in the same manner as in Example 1, except that the negative electrode active material was replaced with a mixture of 47.5 mass parts of natural graphite having a number average particle size of 10 μm, 47.5 mass parts of artificial graphite and 1 mass parts of carbon-coated SiO identical to what was produced in Example 3.

Further, a non-aqueous electrolyte was prepared in the same manner as in Example 1, except that 1,4-bis(propenoxymethyl)cyclohexane was used for the compound A in an amount of 0.2 mass %, 3-amino-1,2,4-triazole was used for the compound C in an amount of 0.2 mass %, the compound B was not used, and 4-fluoro-1,3-dioxolane-2-on was added further in an amount of 0.1 mass %.

And, a non-aqueous secondary battery was produced in the same manner as in Example 13, except that the above-described non-aqueous electrolyte was used.

### Comparative Example 1

A non-aqueous electrolyte was prepared in the same manner as in Example 1, except that 1,3-bis(vinyloxymethyl)cycloheptane was used for the compound A in an amount of 1 mass %, and neither the compound B nor the compound C was used. And a non-aqueous secondary battery was produced in the same manner as in Example 1 except that the above-described non-aqueous electrolyte was used.

### Comparative Example 2

A non-aqueous electrolyte was prepared in the same manner as in Example 1, except that 1,7-bis(3-fluoromethyl butenoate)-2,3-benzo-1,7-diaza-15-crown-5-ether was used for the compound B in an amount of 1 mass %, and neither the compound A nor the compound C was used. And a non-aqueous secondary battery was produced in the same manner as in Example 2, except that the above-described non-aqueous electrolyte was used.

### Comparative Example 3

A non-aqueous electrolyte was prepared in the same manner as in Example 1 except that 2-amino-1,3,6-triazine was used for the compound C in an amount of 1 mass %, and neither the compound A nor the compound B was used. And a non-aqueous secondary battery was produced in the same manner as in Example 3, except that the above-described non-aqueous electrolyte was used.

### Comparative Example 4

A non-aqueous electrolyte was prepared in the same manner as in Example 1, except that the compound A, the compound B and the compound C were not used. And a non-aqueous secondary battery was produced in the same manner as in Example 9, except that the above-described non-aqueous electrolyte was used.

### Comparative Example 5

A non-aqueous electrolyte was prepared in the same manner as in Example 1, except that the compound A, the compound B and the compound C were not used. And a non-aqueous secondary battery was produced in the same manner as in Example 15, except that the above-described non-aqueous electrolyte was used.

### Comparative Example 6

A non-aqueous electrolyte was prepared in the same manner as in Example 1, except that the compound A, the compound B and the compound C were not used, and 4-fluoro-1,3-dioxolane-2-on was added in an amount of 1 mass %. And a non-aqueous secondary battery was produced in the same manner as in Example 15, except that the above-described non-aqueous electrolyte was used.

Each of the following evaluations was performed on the non-aqueous secondary batteries of Examples 1 to 23 and Comparative Examples 1 to 6.

<Measurement of Capacity>

Each of the batteries of Examples 1 to 23 and Comparative Examples 1 to 6 was stored for 7 hours at 60° C. Subsequently, at 20° C., each of the batteries was charged at a current of 200 mA for 5 hours, and then discharged at a current of 200 mA until the battery voltage dropped to 3 V and the charging and the discharging were repeated in cycles until the discharged capacity became constant. Next, each of the batteries was charged at a constant current and a constant voltage (constant current: 500 mA, constant voltage: 4.2 V, and total charging time: 3 hours), and then brought to a standstill for 1 hour. Subsequently, each of the batteries was discharged at a current of 200 mA until the battery voltage became 3 V, and the standard capacity of each of the batteries was determined. In calculating the standard capacity, 20 batteries for each Example were measured, and the average of the measured values was taken as the standard capacity of the battery of each of Examples and Comparative Examples.

<Charge/Discharge Cycle Characteristics>

For the batteries in Examples 1 to 23 and Comparative Examples 1 to 6, charge and discharge cycles were repeated, in which a constant-current and constant-voltage charge was performed under the same conditions as the measurement of the standard capacity and brought to a standstill for 1 minute, and then each of the batteries was discharged at 200 mA until the battery voltage reached 3V. The number of cycles was counted until the discharged capacity was reduced to 70% of the discharged capacity in the first cycle. Thus, the charge cycle characteristics of each of the batteries were evaluated. In calculating the number of cycles for the charge/discharge cycle characteristics, 2 batteries for each example were measured, and the average of the numbers of cycles was taken as the number of cycles in each of Examples and Comparative Examples.

<Storage Characteristics>

Each of the batteries of Examples 1 to 23 and Comparative Examples 1 to 6 was charged at a constant current and a constant voltage (constant current: 400 mA, constant voltage: 4.25 V, and total charging time: 3 hours). Subsequently, each of the batteries was placed in a thermostatic oven and left there for 5 days at 80° C., and then the thickness of each of the batteries was measured. Evaluation on the storage characteristics was carried out on the basis of the change in the thickness calculated from the difference between the thickness after the storage of each battery obtained in this manner and the thickness before the storage (4.0 mm) (the difference between the thickness of each battery before and after the storage, which corresponds to swelling of the battery during the storage).

For the non-aqueous secondary batteries of Examples 1 to 23 and Comparative Examples 1 to 6, the compositions of the positive electrode active materials used for the positive electrodes (mass part) are shown in Table 1. The additives used for preparation of the non-aqueous electrolytes (additives other than vinylene carbonate) and the addition amounts are shown in Tables 2 to 6. The negative electrode active materials used for the negative electrodes are shown in Table 7, and the respective evaluation results are shown in Table 8.

TABLE 1

| | Composition of positive |
|---|---|
| | electrode active material (mass part) |
| Example 1 | Li_{1.06}Ni_{0.6}Co_{0.2}Mn_{0.2}O₂ |
| Example 2 | Li_{1.03}Ni_{0.9}Co_{0.05}Mn_{0.025}Mg_{0.025}O₂ |
| Example 3 | Li_{1.00}Ni_{0.5}Co_{0.2}Mn_{0.3}O₂ |
| Example 4 | Li_{1.03}Ni_{0.9}Co_{0.05}Mn_{0.025}Mg_{0.025}O₂(95 mass parts) |
| | Li_{1.02}Mn_{1.976}Al_{0.01}Mg_{0.01}Ti_{0.004}O₄ (5 mass parts) |
| Example 5 | Li_{1.03}Ni_{0.9}Co_{0.05}Mn_{0.025}Mg_{0.025}O₂ (90 mass parts) |
| | Li_{1.00}Co_{0.988}Al_{0.005}Mg_{0.005}Zr_{0.002}O₂ (10 mass parts) |
| Example 6 | Li_{1.03}Ni_{0.9}Co_{0.05}Mn_{0.025}Mg_{0.025}O₂ (90 mass parts) |
| | Li_{1.00}Fe_{0.988}Mg_{0.1}Ti_{0.002}PO₄ (10 mass parts) |
| Example 7 | Li_{1.02}Ni_{0.4}Co_{0.3}Mn_{0.3}O₂ (90 mass parts) |
| | Li_{1.02}Mn_{1.488}Ni_{0.49}Al_{0.01}Mg_{0.01}Ti_{0.002}O₄ |
| | (10 mass parts) |
| Example 8 | Li_{1.00}Ni_{0.45}Co_{0.1}Mn_{0.45}O₂ |
| Example 9 | Li_{1.02}Ni_{0.34}Co_{0.34}Mn_{0.32}O₂ |
| Example 10 | Li_{1.02}Ni_{0.4}Co_{0.3}Mn_{0.3}O₂ (90 mass parts) |
| | Li_{1.2}Mn_{0.48}Ni_{0.16}Co_{0.16}O₂ (10 mass parts) |
| Example 11 | Li_{1.06}Ni_{0.6}Co_{0.2}Mn_{0.2}O₂ |
| Example 12 | Li_{1.06}Ni_{0.6}Co_{0.2}Mn_{0.2}O₂ |
| Example 13 | Li_{1.06}Ni_{0.6}Co_{0.2}Mn_{0.2}O₂ |
| Example 14 | Li_{1.06}Ni_{0.6}Co_{0.2}Mn_{0.2}O₂ |
| Example 15 | Li_{1.03}Ni_{0.9}Co_{0.05}Mn_{0.025}Mg_{0.025}O₂ |
| Example 16 | Li_{1.02}Ni_{0.82}Co_{0.15}Al_{0.03}O₂ |
| Example 17 | Li_{1.03}Ni_{0.9}Co_{0.05}Mn_{0.025}O₂ |
| Example 18 | Li_{1.06}Ni_{0.6}Co_{0.2}Mn_{0.2}O₂ |
| Example 19 | Li_{1.03}Ni_{0.9}Co_{0.05}Mn_{0.025}Mg_{0.025}O₂ |
| Example 20 | Li_{1.03}Ni_{0.9}Co_{0.05}Mn_{0.025}Mg_{0.025}O₂ |
| Example 21 | Li_{1.00}Ni_{0.5}Co_{0.2}Mn_{0.3}O₂ |
| Example 22 | Li_{1.06}Ni_{0.6}Co_{0.2}Mn_{0.2}O₂ |
| Example 23 | Li_{1.06}Ni_{0.6}Co_{0.2}Mn_{0.2}O₂ |
| Comparative | Li_{1.06}Ni_{0.6}Co_{0.2}Mn_{0.2}O₂ |
| Example 1 | |
| Comparative | Li_{1.03}Ni_{0.9}Co_{0.05}Mn_{0.025}Mg_{0.025}O₂ |
| Example 2 | |
| Comparative | Li_{1.00}Ni_{0.5}Co_{0.2}Mn_{0.3}O₂ |
| Example 3 | |
| Comparative | Li_{1.02}Ni_{0.34}Co_{0.34}Mn_{0.32}O₂ |
| Example 4 | |
| Comparative | Li_{1.03}Ni_{0.9}Co_{0.05}Mn_{0.025}Mg_{0.025}O₂ |
| Example 5 | |
| Comparative | Li_{1.03}Ni_{0.9}Co_{0.05}Mn_{0.025}Mg_{0.025}O₂ |
| Example 6 | |

TABLE 2

| | | | Addition |
|---|---|---|---|
| | | | amount |
| | Additive added to non-aqueous electrolyte | | (mass %) |
| Example 1 | Compound A | 1,3-bis(propenoxymethyl)cyclopentane | 0.2 |
| | Compound B | 1,7-bis(butenoic acid)-1,7-diaza-12-crown-4-ether | 0.2 |
| | Compound C | 1,2,4-triazole | 0.1 |
| Example 2 | Compound A | 1,3-bis(propenoxymethyl)cyclohexane | 0.2 |
| | Compound B | 1,7-bis(2-methyl butenoate)-1,7-diaza-15-crown-5- | 0.1 |
| | | ether | |
| | Compound C | 3-amino-1,2,4-triazole | 0.1 |
| Example 3 | Compound A | 1,3-bis(propenoxyethyl)cycloheptane | 0.1 |
| | Compound B | 1,10-bis(2-ethyl butenoate)-1,10-diaza-18-crown-6- | 0.2 |
| | | ether | |
| | Compound C | 4-methyl-1,2,3-triazole | 0.1 |
| Example 4 | Compound A | 1,3-bis(vinyloxyethyl)cycloheptane | 0.1 |
| | Compound B | 1,10-bis(2-ethyl pentenoate)-2,3,14,15-dibenzo-1, | 0.15 |
| | | 10-diaza-18-crown-6-ether | |
| | Compound C | 4-amino-1,3-imidazole | 0.15 |
| Example 5 | Compound A | 1,3-bis(propenoxymethyl)cyclopentane | 0.1 |
| | Compound B | 1,7-bis(3-fluoromethyl butenoate)-2,3-benzo-1,7- | 0.1 |
| | | diaza-15-crown-5-ether | |
| | Compound C | 4-amino-1,2-pyrazole | 0.1 |
| Example 6 | Compound A | 1,3-bis(propenoxymethyl)cyclopentane | 2 |
| | Compound B | 1,7-bis(3-trifluoromethyl methyl butenoate)-1,7- | 2 |
| | | diaza-15-crown-5-ether | |
| | Compound C | 2-amino-1,3-pyrimidine | 1 |
| Example 7 | Compound A | 1,3-bis(propenoxymethyl)cyclopentane | 1 |
| | Compound B | 1,7-bis(1-acryloylmethl)-1,7-diaza-15-crown-5- | 0.5 |
| | | Ether | |
| | Compound C | 2-amino-1,3,6-triazine | 0.5 |

TABLE 3

| | | | Addition |
|---|---|---|---|
| | | | amount |
| | Additive added to non-aqueous electrolyte | | (mass %) |
| Example 8 | Compound A | 1,3-bis(propenoxymethyl)cyclopentane | 0.02 |
| | Compound B | 1,4-bis(1-acryloylethyl)-1,4-diaza-15-crown-5- | 0.05 |
| | | Ether | |
| | Compound C | 5-amino-indole | 0.02 |
| Example 9 | Compound A | 1,3-bis(propenoxymethyl)cyclohexane | 0.2 |
| | Compound B | 1,7-bis(2-methyl butenoate)-1,7-diaza-15-crown-5- | 0.2 |
| | | ether | |
| | Compound C | — | — |
| Example 10 | Compound A | 1,3-bis(propenoxymethyl)cyclohexane | 1 |
| | Compound B | — | — |
| | Compound C | 3-amino-1,2,4-triazole | 0.5 |
| Example 11 | Compound A | 1,3-bis(propenoxymethyl)cyclopentane | 0.2 |
| | Compound B | 1,7-bis(butenoic acid)-1,7-diaza-12-crown-4- | 0.2 |
| | | Ether | |
| | Compound C | 1,2,4-triazole | 0.1 |
| Example 12 | Compound A | 1,3-bis(propenoxymethyl)cyclopentane | 0.2 |
| | Compound B | 1,7-bis(butenoic acid)-1,7-diaza-12-crown-4- | 0.2 |
| | | Ether | |
| | Compound C | 1,2,4-triazole | 0.1 |
| | | propane sultone | 0.1 |
| Example 13 | Compound A | 1,3-bis(propenoxymethyl)cyclopentane | 0.2 |
| | Compound B | 1,7-bis(butenoic acid)-1,7-diaza-12-crown-4- | 0.2 |
| | | Ether | |
| | Compound C | 1,2,4-triazole | 0.1 |
| | | 4-fluoro-1,3-dioxolane-2-on | 0.1 |
| Example 14 | Compound A | 1,3-bis(propenoxymethyl)cyclopentane | 0.2 |
| | Compound B | 1,7-bis(butenoic acid)-1,7-diaza-12-crown-4- | 0.2 |
| | | Ether | |
| | Compound C | 1,2,4-triazole | 0.1 |
| | | (n-trifluoropropyl)ethylether | 0.1 |

TABLE 4

| | | | Addition |
|---|---|---|---|
| | | | amount |
| | Additive added to non-aqueous electrolyte | | (mass %) |
| Example 15 | Compound A | 1,4-bis(propenoxymethyl)cyclohexane | 0.2 |
| | Compound B | 1,7-bis(2-methyl butenoate)-1,7-diaza-15-crown-5- | 0.2 |
| | | ether | |
| | Compound C | — | — |
| | | 4-fluoro-1,3-dioxolane-2-on | 1 |
| Example 16 | Compound A | 1,4-bis(propenoxymethyl)cyclohexane | 0.2 |
| | Compound B | 1,7-bis(2-methyl butenoate)-1,7-diaza-15-crown-5- | 0.2 |
| | | ether | |
| | Compound C | — | — |
| | | trans-4,5-difluoro-1,3-dioxolane-2-on | 0.5 |
| Example 17 | Compound A | 1,4-bis(propenoxymethyl)cyclohexane | 0.2 |
| | Compound B | — | — |
| | Compound C | 3-amino-1,2,4-triazole | 0.2 |
| | | 4-fluoro-1,3-dioxolane-2-on | 1 |
| Example 18 | Compound A | 1,4-bis(propenoxymethyl)cyclohexane | 0.2 |
| | Compound B | — | — |
| | Compound C | 3-amino-1,2,4-triazole | 0.2 |
| | | fluoroethyl propylether | 5 |
| Example 19 | Compound A | 1,4-bis(propenoxymethyl)cyclohexane | 0.2 |
| | Compound B | — | — |
| | Compound C | 3-amino-1,2,4-triazole | 0.2 |
| | | fluoropropylethyl carbonate | 0.7 |
| Example 20 | Compound A | 1,4-bis(propenoxymethyl)cyclohexane | 0.2 |
| | Compound B | — | — |
| | Compound C | 3-amino-1,2,4-triazole | 0.2 |
| | | trifluoropropylene carbonate | 1.0 |

TABLE 5

| | | | Addition |
|---|---|---|---|
| | | Additive added to | amount |
| | | non-aqueous electrolyte | (mass %) |
| Exam- | Compound A | 1,4- | 0.1 |
| ple 21 | | bis(propenoxymethyl)cyclohexane | |
| | Compound B | — | — |
| | Compound C | 3-amino-1,2,4-triazole | 0.1 |
| | | 4-fluoro-1,3-dioxolane-2-on | 0.1 |
| Exam- | Compound A | 1,4- | 0.2 |
| ple 22 | | bis(propenoxymethyl)cyclohexane | |
| | Compound B | — | — |
| | Compound C | 3-amino-1,2,4-triazole | 0.2 |
| | | 4-fluoro-1,3-dioxolane-2-on | 0.1 |
| Exam- | Compound A | 1,4- | 0.2 |
| ple 23 | | bis(propenoxymethyl)cyclohexane | |
| | Compound B | — | — |
| | Compound C | 3-amino-1,2,4-triazole | 0.2 |
| | | 4-fluoro-1,3-dioxolane-2-on | 0.1 |

TABLE 6

| | | | Addition |
|---|---|---|---|
| | Additive added to | | amount |
| | non-aqueous electrolyte | | (mass %) |
| Comparative | Compound A | 1,3-bis(vinyloxymethyl)cycloheptane | 1 |
| Example 1 | Compound B | — | — |
| | Compound C | — | — |
| Comparative | Compound A | — | — |
| Example 2 | Compound B | 1,7-bis(3-fluoromethyl butenoate)-2,3-benzo-1,7- | 1 |
| | | diaza-15-crown-5-ether | |
| | Compound C | — | — |
| Comparative | Compound A | — | — |
| Example 3 | Compound B | — | — |
| | Compound C | 2-amino-1,3,6-triazine | 1 |
| Comparative | Compound A | — | — |
| Example 4 | Compound B | — | — |
| | Compound C | — | — |
| Comparative | Compound A | — | — |
| Example 5 | Compound B | — | — |
| | Compound C | — | — |
| Comparative | Compound A | — | — |
| Example 6 | Compound B | — | — |
| | Compound C | — | — |
| | | 4-fluoro-1,3-dioxolane-2-on | 1 |

TABLE 7

| | Negative electrode active material |
|---|---|
| Example 1 | natural graphite |
| Example 2 | natural graphite, artificial graphite |
| Example 3 | natural graphite, artificial graphite, SiO |
| Example 4 | natural graphite, mesophase carbon |
| Example 5 | artificial graphite, mesophase carbon |
| Example 6 | natural graphite, artificial graphite |
| Example 7 | natural graphite, mesophase carbon |
| Example 8 | natural graphite, artificial graphite |
| Example 9 | artificial graphite, mesophase carbon |
| Example 10 | natural graphite, artificial graphite |
| Example 11 | natural graphite, artificial graphite |
| Example 12 | natural graphite, artificial graphite |
| Example 13 | natural graphite, mesophase carbon, SiO |
| Example 14 | artificial graphite, mesophase carbon, SiO |
| Example 15 | natural graphite, artificial graphite, SiO |
| Example 16 | natural graphite, artificial graphite, SiO |
| Example 17 | natural graphite, artificial graphite, SiO |
| Example 18 | natural graphite, artificial graphite, SiO |
| Example 19 | natural graphite, artificial graphite, SiO |
| Example 20 | natural graphite, artificial graphite, SiO |
| Example 21 | natural graphite, artificial graphite, SiO |
| Example 22 | natural graphite, mesophase carbon, SiO |
| Example 23 | natural graphite, artificial graphite, SiO, |
| | Li₄Ti₅O₁₂ |
| Comparative Example 1 | natural graphite |
| Comparative Example 2 | natural graphite, artificial graphite |
| Comparative Example 3 | natural graphite, artificial graphite, SiO |
| Comparative Example 4 | artificial graphite, mesophase carbon |
| Comparative Example 5 | natural graphite, artificial graphite, SiO |
| Comparative Example 6 | natural graphite, artificial graphite, SiO |

TABLE 8

| | Standard | | |
|---|---|---|---|
| | capacity | Cycle number | Thickness difference before |
| | (mAh) | (number) | and after storage (mm) |
| Example 1 | 1030 | 545 | 0.8 |
| Example 2 | 1059 | 532 | 0.9 |
| Example 3 | 992 | 504 | 1.0 |
| Example 4 | 1051 | 523 | 0.9 |
| Example 5 | 1055 | 537 | 0.7 |
| Example 6 | 1048 | 541 | 0.7 |
| Example 7 | 629 | 501 | 1.0 |
| Example 8 | 944 | 516 | 0.9 |
| Example 9 | 863 | 538 | 0.6 |
| Example 10 | 945 | 452 | 1.0 |
| Example 11 | 1036 | 567 | 0.8 |
| Example 12 | 1025 | 553 | 0.7 |
| Example 13 | 1027 | 562 | 1.0 |
| Example 14 | 1028 | 558 | 1.0 |
| Example 15 | 1082 | 515 | 1.0 |
| Example 16 | 1046 | 544 | 0.9 |
| Example 17 | 1079 | 520 | 1.0 |
| Example 18 | 1044 | 533 | 1.0 |
| Example 19 | 1077 | 508 | 0.8 |
| Example 20 | 1080 | 510 | 1.0 |
| Example 21 | 998 | 580 | 0.6 |
| Example 22 | 1030 | 577 | 0.8 |
| Example 23 | 1012 | 573 | 0.7 |
| Comparative | 715 | 102 | 0.5 |
| Example 1 | | | |
| Comparative | 1059 | 328 | 1.8 |
| Example 2 | | | |
| Comparative | 992 | 285 | 1.9 |
| Example 3 | | | |
| Comparative | 863 | 485 | 1.6 |
| Example 4 | | | |
| Comparative | 1078 | 210 | 0.8 |
| Example 5 | | | |
| Comparative | 1083 | 520 | 2.0 |
| Example 6 | | | |

As illustrated in Table 8, in the evaluation of the charge/discharge cycle characteristics of the non-aqueous secondary batteries of Examples 1 to 23 where lithium-containing composite oxides of appropriate compositions are the positive electrode active materials and non-aqueous electrolytes of appropriate compositions are used, the cycle number by the time the discharge capacity is reduced to 70% of the first cycle is large, namely the charge/discharge cycle characteristics are excellent. In addition, the thickness does not change so much before and after the storage, namely the storage characteristics also are excellent. And, the balance between the charge/discharge cycle characteristics and the storage characteristics is more favorable in comparison with the batteries according to Comparative Examples 1 to 6.

Further, each of the non-aqueous secondary batteries in Examples 15 to 20 uses a negative electrode made of a negative electrode active material containing a relatively large amount of SiO that contributes to high capacity of the battery but often causes deterioration of the charge/discharge cycle characteristics of the battery. The deterioration of the charge/discharge cycle characteristics of the battery caused by SiO can be confirmed with reference to the battery of Comparative Example 5. Specifically in Comparative Example 5, a negative electrode identical to that of the battery in each of Examples 15 to 20 is used, and a non-aqueous electrolyte that does not contain the compound A, the compound B and the compound C is used, while in Comparative Example 4, a non-aqueous electrolyte identical to that of Comparative Example 5 is used and a negative electrode that does not contain SiO is used. The charge/discharge cycle characteristics of Comparative Example 5 is inferior to those of Comparative Example 4.

However, the batteries of Examples 15 to 20 have superior charge/discharge cycle characteristics in comparison with, for example, the battery of Example 3 where a negative electrode made of a negative electrode active material containing a smaller amount of SiO. The reason is considered as follows. To each of the non-aqueous electrolytes used for the non-aqueous secondary batteries of Examples 15 to 20, a fluorine-containing additive is added together with the compound A, the compound B and the compound C. Due to the action, a favorable film was formed on the SiO surface of the negative electrode, and thus further favorable charge/discharge cycle characteristics were secured. Similarly, the fluorine-containing additive is added to the non-aqueous electrolyte in each of the batteries of Example 13 and Example 14 where the content of SiO in the negative electrode active material of the negative electrode is equivalent to that of the battery of Example 3. The batteries of both Example 13 and Example 14 also are superior in the charge/discharge cycle characteristics to the battery of Example 3. This result indicates the effect provided by the addition of the fluorine-containing additive together with the compound A, the compound B and the compound C.

The battery of Comparative Example 6 uses a negative electrode identical to that of each Examples 15 to 20, and uses a non-aqueous electrolyte that does not contain any of the compound A, the compound B and the compound C while to which a fluorine-containing additive is added. This battery has excellent charge/discharge cycle characteristics and addition of the fluorine-containing additives has been confirmed as effective. However, the thickness changes greatly before and after the storage, and swelling due to the storage is large. This is considered as being caused by a gas. Namely, a compound (reaction product) residing at the time of forming a film derived from the fluorine-containing additive is decomposed at the positive electrode during the storage of the battery so as to generate the gas. On the other hand, each of the batteries of Examples 15 to 20 uses the non-aqueous electrolyte containing the compound A, the compound B and the compound C together with the fluorine-containing additive. In these batteries, the thickness change before and after the storage is small, and the reason is considered as follows. The action of the compound A inhibits the decomposition of the compound derived from the fluorine-containing additive at the positive electrode, thereby suppressing the gas generation.

Each of the batteries of Examples 21 and 22 uses a negative electrode including SiO, and the battery of Example 23 uses a negative electrode including SiO and Li₄Ti₅O₁₂. These batteries each has a high capacity, excellent charge/discharge cycle characteristics, small change in the thickness before and after the storage, and excellent storage characteristics because of the use of the compound A, the compound B and the compound C.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

### EXPLANATION OF LETTERS AND NUMERALS

1 positive electrode
2 negative electrode
3 separator
4 battery case
5 insulator
6 wound electrode assembly
7 positive electrode lead connector
8 negative electrode lead connector
9 cover plate
10 insulation packing
11 terminal
12 insulator
13 lead plate
14 inlet
15 rupture vent

1. A non-aqueous secondary battery comprising a positive electrode, a negative electrode, a separator and a non-aqueous electrolyte, wherein
the positive electrode comprises a lithium-containing composite oxide as a positive electrode active material;
the lithium-containing composite oxide is expressed by a general compositional formula (1) below:
Li_{1+y}MO₂ (1)
where −0.5≦y≦0.5, and M denotes an element group including Ni and at least one element selected from the group consisting of Co, Mn, Fe and Ti,
when the percentages of the element number of Ni, Co, Mn, Fe and Ti comprised in the element group M are denoted as a (mol %), b (mol %), c (mol %), d (mol %) and e(mol %) respectively, 30≦a≦95, b≦40, c≦40, d≦30, e≦30 and 5≦b+c+d+e≦60, and
the non-aqueous electrolyte comprises a cycloalkane derivative A having at least one alkyl ether group containing an unsaturated bond, and at least one compound selected from the group consisting of an azacrown ether compound B having a functional group where at least one of nitrogen atoms contains an unsaturated bond and a nitrogen-containing heterocyclic compound C.

2. The non-aqueous secondary battery according to claim 1, wherein the non-aqueous electrolyte comprises the azacrown ether compound B and the nitrogen-containing heterocyclic compound C.

3. The non-aqueous secondary battery according to claim 1, wherein the cycloalkane derivative A is either alkenoxy methyl cycloalkane or alkenoxy ethyl cycloalkane.

4. The non-aqueous secondary battery according to claim 1, wherein the azacrown ether skeleton of the azacrown ether compound B comprises a plurality of nitrogen atoms.

5. The non-aqueous secondary battery according to claim 1, wherein the functional group of the azacrown ether compound B containing an unsaturated bond is at least one functional group selected from the group consisting of a functional group expressed by a general structural formula (1) below or a (meth)acryloyl alkyl group: 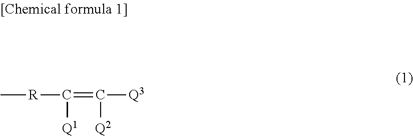
where R is alkylene having a carbon number in the range of 1 to 3; Q¹, Q² and Q³ are independently a hydrogen atom, a fluorine atom, an alkyl group having a carbon number in the range of 1 to 3, a fluoroalkyl group having a carbon number in the range of 1 to 2, a cyano group, a carboxyl group, a carboxyalkyl group having a carbon number in the range of 3 to 5, an alkoxy group having a carbon number in the range of 1 to 3, an alkoxycarbonyl group having a carbon number in the range of 2 to 4, or an alkylene alkyl carbonate group having a carbon number in the range of 3 to 5.

6. The non-aqueous secondary battery according to claim 1, wherein the nitrogen-containing heterocyclic compound C is at least one selected from the group consisting of imidazoles, pyrazoles, triazoles, pyrimidines, and triazines.

7. The non-aqueous secondary battery according to claim 1, wherein the content of the cycloalkane derivative Ain the non-aqueous electrolyte is 0.01 to 5% by mass with respect to the whole mass of the non-aqueous electrolyte.

8. The non-aqueous secondary battery according to claim 1, wherein the content of the azacrown ether compound B in the non-aqueous electrolyte is 0.02 to 5% by mass with respect to the whole mass of the non-aqueous electrolyte.

9. The non-aqueous secondary battery according to claim 1, wherein the content of the nitrogen-containing heterocyclic compound C in the non-aqueous electrolyte is 0.01 to 3% by mass with respect to the whole mass of the non-aqueous electrolyte.

10. The non-aqueous secondary battery according to claim 1, wherein the element group M of the general compositional formula (1) further comprises at least one element selected from the group consisting of an element of IIA group and an element of IIIB group.

11. The non-aqueous secondary battery according to claim 1, wherein y>0 in the general compositional formula (1).

12. The non-aqueous secondary battery according to claim 1, wherein the negative electrode comprises as a negative electrode active material, a carbon material capable of occluding or desorbing a lithium ion, a material composed of an element capable of being alloyed with lithium, or a material comprising an element capable of being alloyed with lithium.

13. The non-aqueous secondary battery according to claim 1, wherein the negative electrode comprises as a negative electrode active material, a material comprising silicon and oxygen as constituent elements and graphite.

14. The non-aqueous secondary battery according to claim 13, wherein the material comprising silicon and oxygen as constituent elements is expressed by a general compositional formula (2) below:
SiOₓ (2)
where 0.5≦x≦1.5.

15. The non-aqueous secondary battery according to claim 1, wherein the positive electrode comprises a vapor-grown carbon fiber as a conductive assistant.

16. The non-aqueous secondary battery according to claim 1, wherein the non-aqueous electrolyte further comprises sulfonic acid anhydride or sulfonate derivative.

17. The non-aqueous secondary battery according to claim 1, wherein the non-aqueous electrolyte comprises further at least one selected from the group consisting of fluoroethers and fluorocarbonates.

18. The non-aqueous secondary battery according to claim 1, wherein the non-aqueous electrolyte comprises further either borates or phosphates.

19. The non-aqueous secondary battery according to claim 1, wherein the separator comprises a first porous layer primarily containing a thermoplastic resin and a second porous layer primarily containing inorganic fine particles having a heat resistant temperature of 200° C. or higher.

20. The non-aqueous secondary battery according to claim 19, wherein the inorganic fine particles are at least one kind of fine particles selected from the group consisting of alumina, silica and boehmite.
